(19) United States
(12) Patent Application Publication
(10) Pub. No.: US 2021/0297638 A1
(43) Pub. Date: Sep. 23, 2021

(54) IMAGE-CAPTURING APPARATUS AND IMAGE-CAPTURING SYSTEM

(71) Applicant: SONY SEMICONDUCTOR SOLUTIONS CORPORATION, KANAGAWA (JP)

(72) Inventor: TOSHINOBU SUGIYAMA, TOKYO (JP)

(21) Appl. No.: 17/250,515

(22) PCT Filed: Jul. 19, 2019
(86) PCT No.: PCT/JP2019/028392

§ 371 Date: Jan. 31, 2021

(30) Foreign Application Priority Data
Aug. 7, 2018 (JP) 2018-148195

(51) Int. Cl. H04N 9/04; H04N 5/225; G02B 5/20

(52) U.S. Cl. CPC H04N 9/04553; H04N 9/04559; G02B 5/208; G02B 5/201; H04N 5/2256

(57) ABSTRACT

An image-capturing apparatus of the present disclosure includes a first pixel having a first color filter that transmits a wavelength band corresponding to first color light that is visible light and an infrared light cutoff filter that limits transmission of an infrared light wavelength band, a second pixel having a second color filter that transmits a wavelength band corresponding to second color light that is visible light and the infrared light cutoff filter, a third pixel having a third color filter that transmits a wavelength band corresponding to third color light that is visible light and the infrared light cutoff filter, a fourth pixel having transmission characteristics of transmitting the infrared light wavelength band, and a fifth pixel having wavelength transmission characteristics that are different from all of the first pixel, the second pixel, the third pixel, and the fourth pixel.

### TECHNICAL FIELD

The present disclosure relates to an image-capturing apparatus and an image-capturing system, and in particular relates to an image-capturing apparatus that can simultaneously acquire visible light and infrared light (IR: infrared) and an image-capturing system that uses the image-capturing apparatus.

### BACKGROUND ART

In recent years, image-capturing apparatuses that can simultaneously acquire visible light and infrared light (infrared rays) are attracting attention. For security-related uses such as face authentication or iris authentication used in personal computers, smartphones and the like and such uses as distance measurement or object recognition in the dark used in vehicle-mounted forms, or for monitoring, games and the like, this type of image-capturing apparatus can simultaneously realize the normal image-capturing functions for color images and the sensing functions for those uses by means of infrared light.

In order to avoid the entrance of infrared light into pixels for reception of visible light in image-capturing apparatuses that can simultaneously acquire visible light and infrared light, R (red), G (green), and B (blue) filters for acquiring visible light and an IR (infrared light) filter for acquiring infrared light are provided in each unit pixel array which is the unit of repetition (see PTL 1, for example).

The conventional technology is based on the premise that double (dual) bandpass filters capable of transmitting the wavelength bands of visible light and particular infrared light (produced infrared light) are provided in front of an image-capturing apparatus. Then, selective infrared light cutoff filters having characteristics of absorbing a wavelength area almost the same as the particular infrared light wavelength band described above are formed further on the R, G, and B filters so that only the wavelength bands of visible light are transmitted to visible light pixels while on the other hand only light of the particular infrared light wavelength band described above is transmitted to infrared light pixels.

### CITATION LIST

### Patent Literature

### [PTL 1]

JP 2017-216678A

### SUMMARY

### Technical Problems

In the conventional technology described in PTL 1 mentioned above, the value of the transmittance of cutoff wavelength areas of the selective infrared light cutoff filters typically is not completely 0% and is approximately 10% to 20%. In addition, typically, the cutoff characteristics of the selective infrared light cutoff filters have instability, and the infrared light transmittance tends to vary within a surface of the image-capturing apparatus and change over time. Because of this, in a calculation for separation between visible light components and infrared light components, such phenomena as undesirable deterioration of the precision of separation between visible light and infrared light or undesirable divergence of the solution of the separation computation occurs. As a result, the image quality is impaired.

An object of the present disclosure is to provide an image-capturing apparatus that can separate visible light and infrared light more precisely even if the infrared light transmittance of selective infrared light cutoff filters is unknown or spatially or temporally unstable.

### Solution to Problems

An image-capturing apparatus of the present disclosure for achieving the object described above has a first pixel having a first color filter that transmits a wavelength band corresponding to first color light that is visible light and an infrared light cutoff filter that limits transmission of an infrared light wavelength band, a second pixel having a second color filter that transmits a wavelength band corresponding to second color light that is visible light and the infrared light cutoff filter, a third pixel having a third color filter that transmits a wavelength band corresponding to third color light that is visible light and the infrared light cutoff filter, a fourth pixel having transmission characteristics of transmitting the infrared light wavelength band, and a fifth pixel having wavelength transmission characteristics that are different from all of the first pixel, the second pixel, the third pixel, and the fourth pixel. In addition, an image-capturing system of the present disclosure for achieving the object described above uses the image-capturing apparatus with the configuration described above.

### BRIEF DESCRIPTION OF DRAWINGS

FIG. 1 is a block diagram illustrating an overview of a configuration of an image-capturing system (camera system) that uses an image-capturing apparatus of the present disclosure.

FIG. 2A is a figure illustrating one example of spectral characteristics of a dual bandpass filter disposed in front of the image-capturing apparatus, and FIG. 2B is a figure illustrating an R-G-B-W color filter array.

FIG. 3A is a figure illustrating a unit pixel array of color filters according to a first example, and FIG. 3B is a figure illustrating one example of spectral characteristics of a selective infrared light cutoff filter.

FIG. 4 is a cross-sectional view illustrating a configuration of a color filter of each pixel of a pixel array section.

FIG. 5A is a figure illustrating a color filter array according to a first modification example of the first example, and FIG. 5B is a figure illustrating a color filter array according to a second modification example of the first example.

FIG. 6A is a figure illustrating a color filter array according to a third modification example of the first example, and FIG. 6B is a figure illustrating a color filter array according to a fourth modification example of the first example.

FIG. 7A is a figure illustrating a color filter array according to a fifth modification example of the first example, and FIG. 7B is a figure illustrating a color filter array according to the fifth modification example of the first example.

FIG. 8A is a figure illustrating a color filter array according to a second example, and FIG. 8B is a figure illustrating a color filter array according to a modification example of the second example.

FIG. 9 is a figure illustrating the unit pixel array of color filters according to a third example.

FIG. 10A is a figure illustrating a color filter array according to a first modification example of the third example, and FIG. 10B is a figure illustrating a color filter array according to a second modification example of the third example.

FIG. 11 is a figure illustrating a color filter array according to a fourth example.

FIG. 12A is a figure illustrating a color filter array according to a first modification example of the fourth example, and FIG. 12B is a figure illustrating a color filter array according to a second modification example of the fourth example.

FIG. 13A is a figure illustrating a color filter array according to a fifth example, and FIG. 13B is a figure illustrating a color filter array according to a modification example of the fifth example.

FIG. 14A is a figure illustrating a color filter array according to a sixth example, and FIG. 14B is a figure illustrating a color filter array according to a modification example of the sixth example.

FIG. 15 is a figure illustrating a color filter array according to a seventh example.

FIG. 16A is a figure illustrating a color filter array according to a first modification example of the seventh example, and FIG. 16B is a figure illustrating a color filter array according to a second modification example of the seventh example.

FIG. 17 is a figure illustrating a color filter array according to an eighth example.

FIG. 18A is a figure illustrating a color filter array according to a first modification example of the eighth example, and FIG. 18B is a figure illustrating a color filter array according to a second modification example of the eighth example.

FIG. 19A is a figure illustrating a color filter array according to a ninth example, and FIG. 19B is a figure illustrating a color filter array according to a first modification example of the ninth example.

FIG. 20A is a figure illustrating a color filter array according to a second modification example of the ninth example, and FIG. 20B is a figure illustrating a color filter array according to a third modification example of the ninth example.

FIG. 21A is a figure illustrating a color filter array according to a tenth example, and FIG. 21B is a figure illustrating a color filter array according to a first modification example of the tenth example.

FIG. 22A is a figure illustrating a color filter array according to a second modification example of the tenth example, and FIG. 22B is a figure illustrating a color filter array according to a third modification example of the tenth example.

FIG. 23A is a figure illustrating a color filter array according to a fourth modification example of the tenth example, and FIG. 23B is a figure illustrating a color filter array according to a fifth modification example of the tenth example.

FIG. 24A is a figure illustrating a color filter array according to an eleventh example, and FIG. 24B is a figure illustrating a color filter array according to a first modification example of the eleventh example.

FIG. 25A is a figure illustrating a color filter array according to a second modification example of the eleventh example, and FIG. 25B is a figure illustrating a color filter array according to a third modification example of the eleventh example.

FIG. 26A is a figure illustrating a color filter array according to a fourth modification example of the eleventh example, and FIG. 26B is a figure illustrating a color filter array according to a fifth modification example of the eleventh example.

FIG. 27A is a figure illustrating a color filter array according to a twelfth example, and FIG. 27B is a figure illustrating a color filter array according to a first modification example of the twelfth example.

FIG. 28A is a figure illustrating a color filter array according to a second modification example of the twelfth example, and FIG. 28B is a figure illustrating a color filter array according to a third modification example of the twelfth example.

FIG. 29A is a figure illustrating a color filter array according to a fourth modification example of the twelfth example, and FIG. 29B is a figure illustrating a color filter array according to a fifth modification example of the twelfth example.

FIG. 30 is a figure illustrating a color filter array according to a thirteenth example.

FIG. 31A is a figure illustrating a color filter array for which each pixel signal, and transmittance k as well, cannot be determined, and FIG. 31B is a figure illustrating a transformation formula in a case of the color filter array.

FIG. 32A is a figure illustrating a color filter array according to a first variation, and FIG. 32B is a figure illustrating a color filter array according to a second variation.

FIG. 33A is a figure illustrating a color filter array according to a third variation, and FIG. 33B is a figure illustrating a color filter array according to a fourth variation.

FIG. 34A is a figure illustrating a color filter array according to a fifth variation, and FIG. 34B is a figure illustrating a color filter array according to a sixth variation.

FIG. 35A is a figure illustrating a color filter array according to a seventh variation, and FIG. 35B is a figure illustrating a color filter array according to an eighth variation.

FIG. 36A is a figure illustrating a color filter array according to a ninth variation, and FIG. 36B is a figure illustrating a color filter array according to a tenth variation.

FIG. 37A is a figure illustrating a color filter array according to an eleventh variation, and FIG. 37B is a figure illustrating a color filter array according to a twelfth variation.

FIG. 38A is a figure illustrating a color filter array according to a thirteenth variation, and FIG. 38B is a figure illustrating a color filter array according to a fourteenth variation.

FIG. 39A is a figure illustrating a color filter array according to a fifteenth variation, and FIG. 39B is a figure illustrating a color filter array according to a sixteenth variation.

FIG. 40 is a figure illustrating a color filter array according to a seventeenth variation.

### DESCRIPTION OF EMBODIMENTS

Hereinafter, modes (hereinafter, described as embodiments) for carrying out the technology of the present disclosure are explained in detail by using the drawings. The technology of the present disclosure is not limited to the embodiments. In the following explanation, identical reference signs are used for identical elements or elements having identical functions, and overlapping explanations are omitted. Note that explanations are given in the following order.

1. Overall Explanation regarding Image-Capturing Apparatus and Image-Capturing System of Present Disclosure

2. Image-Capturing System (Camera System) that Uses Image-Capturing Apparatus of Present Disclosure
2-1. System Configuration
2-2. R-G-B-W Color Filter Array according to Conventional Example

3. Embodiments of Present Disclosure
3-1. First Example (Example based on R-G-B-W Pixel Array)
3-2. Second Example (Example based on R-G-B-W Pixel Array in which Half of W Pixels are Replaced with GI Pixels)
3-3. Third Example (Example based on R-G-B-IR Pixel Array)
3-4. Fourth Example (Example based on R-G-B-IR Pixel Array in which Number of G Pixel is Increased)
3-5. Fifth Example (Example based on R-G-B-IR Pixel Array in which Half of G Pixels are Replaced with WS Pixels)
3-6. Sixth Example (Example based on R-G-B-IR Pixel Array in which Half of IR Pixels are Replaced with kIR Pixel)
3-7. Seventh Example (Example of R-G-B-IR Pixel Array in which Half of IR Pixels are Replaced with W Pixels)
3-8. Eighth Example (Example of R-G-B-W Pixel Array in which Half of G Pixels are Replaced with IR Pixels)
3-9. Ninth Example (Example based on R-B-W-WS-IR Pixel Array)
3-10. Tenth Example (Example based on R-G-B-IR Pixel Array in which Half of R Pixels are Replaced with YI Pixels)
3-11. Eleventh Example (Example based on R-G-B-IR Pixel Array in which Half of R Pixels are Replaced with Ye Pixels)
3-12. Twelfth Example (Example in which All Color Filters are Replaced with Complementary Color Filters)
3-13. Thirteenth Example (Example of Dispersed Arrangement of Unit Pixel Arrays for Transmittance Computation)

4. Modification Examples of Embodiments

5. Configurations that can be Adopted in Present Disclosure

### <Overall Explanation Regarding Image-Capturing Apparatus and Image-Capturing System of Present Disclosure>

A possible configuration of the image-capturing apparatus and the image-capturing system of the present disclosure further includes a bandpass filter that transmits a wavelength band corresponding to red, a wavelength band corresponding to green, a wavelength band corresponding to blue, and a first infrared light wavelength band that is a band of wavelengths longer than wavelengths of the wavelength band corresponding to red. This bandpass filter has the function of cutting off a first wavelength band that is a wavelength band between the wavelength band corresponding to red and the first infrared light wavelength band and a second wavelength band that is a band of wavelengths longer than wavelengths of the first infrared light wavelength band. Then, as the bandpass filter, a selective infrared light cutoff filter that limits the transmission of the first infrared light wavelength band is preferably used.

In a possible configuration of the image-capturing apparatus and the image-capturing system of the present disclosure including the preferable configuration mentioned above, a first color filter is a red color filter, a second color filter is a green color filter, and a third color filter is a blue color filter.

Further, in a possible configuration of the image-capturing apparatus and the image-capturing system of the present disclosure including the preferable configuration mentioned above, a fourth pixel is a white pixel not having a color filter formed thereon or an infrared light pixel having transmission characteristics of transmitting an infrared light wavelength band. In addition, in a possible configuration, a fifth pixel is a green pixel not having a selective infrared light cutoff filter formed thereon, a white pixel having the selective infrared light cutoff filter formed thereon, an infrared light pixel having the selective infrared light cutoff filter formed thereon, or a complementary color pixel not having the selective infrared light cutoff filter formed thereon.

Alternatively, in a possible configuration of the image-capturing apparatus and the image-capturing system of the present disclosure including the preferable configuration mentioned above, the first color filter, the second color filter, and the third color filter are complementary color filters. Then, in a possible configuration, the first color filter is a yellow color filter, the second color filter is a magenta color filter, and the third color filter is a cyan color filter.

Further, in a possible configuration of the image-capturing apparatus and the image-capturing system of the present disclosure including the preferable configuration mentioned above, the fourth pixel is an infrared light pixel having transmission characteristics of transmitting an infrared light wavelength band. In addition, in a possible configuration, the fifth pixel is a yellow color filter, a magenta color filter, or a cyan color filter not having the selective infrared light cutoff filter formed thereon.

In addition, in a possible configuration of the image-capturing apparatus and the image-capturing system of the present disclosure including the preferable configuration mentioned above, unit pixel arrays each including the first pixel, the second pixel, the third pixel, the fourth pixel, and the fifth pixel are arranged dispersedly on a pixel array section on which a matrix of pixels is arranged.

### <Image-Capturing System>

First, the configuration of the image-capturing system (camera system) that uses the image-capturing apparatus of the present disclosure is explained.

### [System Configuration]

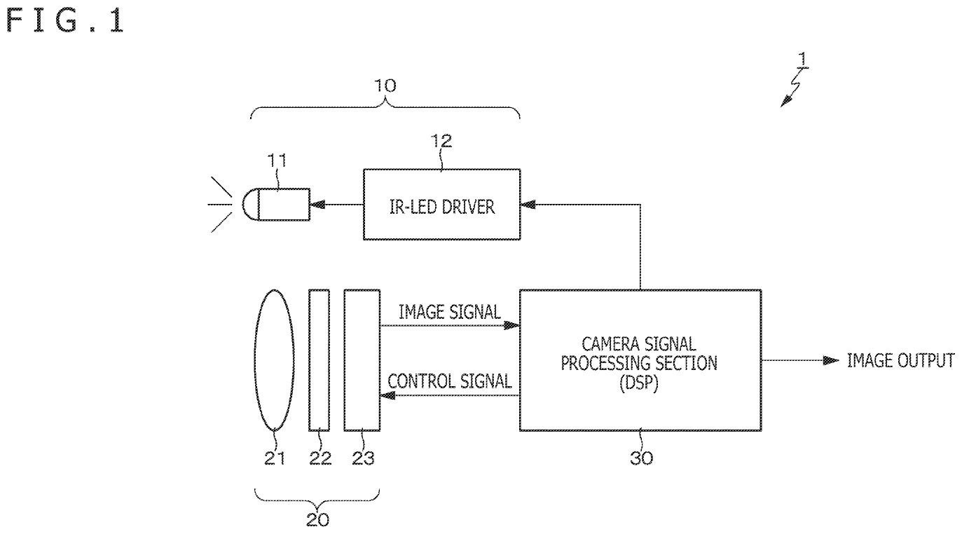

The overview of the configuration of the camera system that uses the image-capturing apparatus of the present disclosure is illustrated in FIG. 1. As illustrated in FIG. 1, a camera system 1 according to the present example has a configuration of having a light source section 10 that produces infrared light (IR), an image-capturing section 20 that captures an image, and a camera signal processing section 30.

The light source section 10 includes an IR-LED 11 which is a light source that emits infrared light (IR) and an IR-LED driver 12 that drives the IR-LED 11. For example, a light emitting diode (LED) that emits infrared light with a wavelength of 850 nm is used as the IR-LED 11.

The image-capturing section 20 includes a lens 21, dual bandpass filters 22, and an image-capturing apparatus 23. In addition, an image-capturing apparatus of the present disclosure mentioned below is used as the image-capturing apparatus 23. Examples of the image-capturing apparatus of the present disclosure include, for example, CMOS (Complementary Metal Oxide Semiconductor) image sensors which are one type of X-Y address type image-capturing apparatus. CMOS image sensors are image sensors fabricated by applying or by partially using CMOS processes.

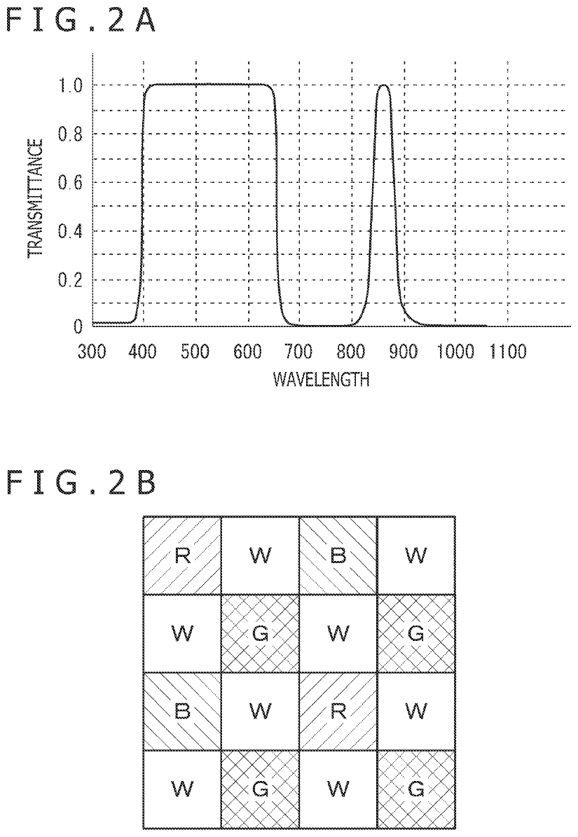

The dual bandpass filters 22 are bandpass filters that transmit a wavelength band corresponding to red (R), a wavelength band corresponding to green (G), a wavelength band corresponding to blue (B), and a first infrared light wavelength band that is a band of wavelengths longer than wavelengths of the wavelength band corresponding to red. The dual bandpass filters 22 have the function of cutting off a second wavelength band that is a wavelength band between the wavelength band corresponding to red and the first infrared light wavelength band and a third wavelength band that is a band of wavelengths longer than wavelengths of the infrared light wavelength band. One example of spectral characteristics of the dual bandpass filters 22 are illustrated in FIG. 2A. As illustrated in FIG. 2A, the dual bandpass filters 22 that are illustrated as an example here have characteristics of transmitting the band of visible light and the first infrared light wavelength band corresponding to infrared light with a wavelength of 850 nm.

The image-capturing apparatus 23 is an image-capturing apparatus that can simultaneously acquire visible light and infrared light. As mentioned earlier, this type of image-capturing apparatus uses a color filter with an R-G-B-IR pixel array, in order to avoid the entrance of infrared light into pixels for receiving visible light. Other than this color filter with the R-G-B-IR pixel array, color filters with an R-G-B-W pixel array are also known as color filters that enable simultaneous acquisition of visible light and infrared light.

Here, W means white pixels not having color filters formed thereon. By not being provided with color filters thereon, W pixels are made sensitive to all bands including visible light and infrared light corresponding to the sensitivity of a silicon substrate itself on which the pixel array is formed.

### [R-G-B-W Color Filter Array According to Conventional Example]

Here, an R-G-B-W color filter array according to a conventional example is explained. The R-G-B-W color filter array according to the conventional example is illustrated in FIG. 2B.

Because there are no pixels dedicated for receiving only infrared light in the R-G-B-W color filter array (pixel array) according to the conventional example, a simultaneous equation like the one illustrated in the following Formula (1) is set up for a reception-light signal of each pixel, and an inverse calculation is performed to thereby perform a computation of the signal strength of each color.

$$( \begin{matrix}{R}_{i} \\ {G}_{i} \\ {B}_{i} \\ {W}_{i}\end{matrix} ) ( \begin{matrix}1 & 0 & 0 & k \\ 0 & 1 & 0 & k \\ 0 & 0 & 1 & k \\ 1 & 1 & 1 & 0\end{matrix} ) ( \begin{matrix}R \\ G \\ B \\ I R\end{matrix} ) \qquad ( 1 )$$

Although it is typically possible to analytically solve the simultaneous equation of Formula (1), calculation errors increase when strong infrared light has mixed into visible light pixels or in other instances in this filter configuration, giving rise to image quality deterioration in terms of color reproduction, noise or the like.

On the other hand, in order to avoid such occurrence of noise, in one possible technique, selective infrared light cutoff filters are formed only on R pixels, G pixels, and B pixels in the R-G-B-W color filter array. Regarding the simultaneous equation described above, a transformation formula representing a matrix in a case where selective infrared light cutoff filters with transmittance k are mounted only above the R pixels, the G pixels, and the B pixels is illustrated in the following Formula (2).

$$( \begin{matrix}R \\ G \\ B \\ IR\end{matrix} ) = \frac{1}{1 - 3 k} \times ( \begin{matrix}2 k & k & k & - k \\ k & 2 k & k & - k \\ k & k & 2 k & - k \\ - 1 & - 1 & - 1 & - 1\end{matrix} ) ( \begin{matrix}{R}_{i} \\ {G}_{i} \\ {B}_{i} \\ {W}_{i}\end{matrix} ) \qquad ( 2 )$$

By determining the inverse matrix of the matrix in the calculation formula of Formula (2) and performing an inverse calculation, it is possible to separate pixel signals corresponding to individual color filters. By doing so, the signal components of infrared light in signals included in the R pixels, the G pixels, and the B pixels are reduced by the amounts corresponding to multiplication of the transmittance k, and accordingly a noise suppression effect can be attained. However, around the transmittance k=⅓ (33%), the determinant (1-3k) in the transformation formula becomes 0, the solution of the inverse calculation diverges undesirably, and it becomes impossible to obtain accurate signal strength.

As mentioned earlier, it is also anticipated that the transmittance of selective infrared light cutoff filters becomes around 33% because the transmittance exhibits spatial and temporal instability. Therefore, on the premise that such changes occur, it becomes difficult to use selective infrared light cutoff filters having finite transmittance in the R-G-B-W color filter array (pixel array).

### Embodiments of Present Disclosure

In view of the problems described above, the embodiments of the present disclosure make it possible to separate visible light and infrared light more precisely even if the infrared light transmittance k of selective infrared light cutoff filters is unknown or spatially or temporally unstable. In addition, the embodiments of the present disclosure make it possible to use selective infrared light cutoff filters also in an R-G-B-W color filter array (pixel array), and similarly to separate visible light and infrared light more precisely.

In order to make it possible to separate visible light and infrared light more precisely, in the present embodiments, new pixel configurations are increased in unit pixel arrays of color filters of the image-capturing apparatus of the present disclosure by combining the presence and absence of selective infrared light cutoff filters, and an input signal, and the transmittance of the selective infrared light cutoff filter as well, is computed for each unit pixel array.

More specifically, the image-capturing apparatus according to the present embodiments is characterized in that it has five types of pixels in a unit pixel array of color filters, and the pixels are a first pixel, a second pixel, a third pixel, a fourth pixel, and a fifth pixel having the following functions.

The first pixel has a first color filter that transmits a wavelength band corresponding to first color light that is visible light and an infrared light cutoff filter that limits the transmission of an infrared light wavelength band. The second pixel has a second color filter that transmits a wavelength band corresponding to second color light that is visible light and the infrared light cutoff filter. The third pixel has a third color filter that transmits a wavelength band corresponding to third color light that is visible light and the infrared light cutoff filter. The fourth pixel has transmission characteristics of transmitting the infrared light wavelength band. The fifth pixel has wavelength transmission characteristics that are different from all of the first pixel, the second pixel, the third pixel, and the fourth pixel.

When a selective infrared light cutoff filter whose infrared light transmittance k varies spatially or temporally is used, the precision of a computation of each signal component can be improved by computing the infrared light transmittance k. As a result, it is possible to attempt to improve image quality indicators such as color reproduction or S/N. In addition, it becomes possible to determine the signal component of each color even in a case where the matrix for determining the signal component of each color diverges otherwise depending on the value of the infrared light transmittance k if a computation for separating visible light and infrared light is performed normally.

In addition, because selective infrared light cutoff filters with unstable infrared light transmittance k can be used, films with lower costs can be used as selective infrared light cutoff filters, and accordingly it is possible to attempt to lower the costs of devices themselves.

Hereinafter, specific examples of the present embodiments are explained. The specific examples have new pixel configurations in a unit pixel array of color filters by combining the presence and absence of selective infrared light cutoff filters, for the purpose of separating visible light and infrared light more precisely.

### First Example

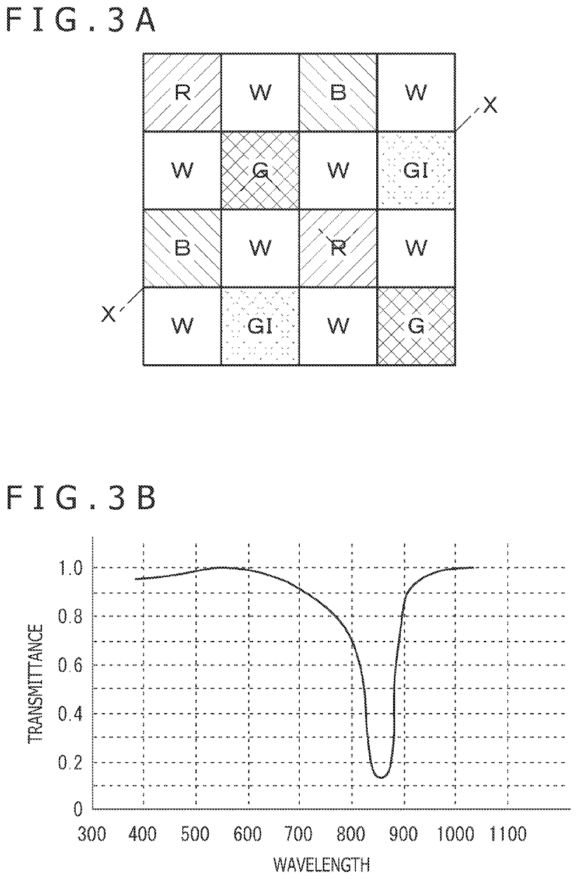

A first example is an example based on the R-G-B-W pixel array. A unit pixel array of color filters according to the first example is illustrated in FIG. 3A. In the first example, by using a four-rows×four-columns color filter array (pixel array) illustrated in FIG. 3A as a unit, each filter is deployed repetitively on an individual pixel of a pixel array section.

Note that, in this configuration, two G pixels in four G pixels in the R-G-B-W unit pixel array have selective infrared light cutoff filters formed thereon, and the two other G pixels do not have selective infrared light cutoff filter formed thereon. The selective infrared light cutoff filters are filters having characteristics of absorbing a wavelength area that is almost the same as the wavelength band of the produced infrared light.

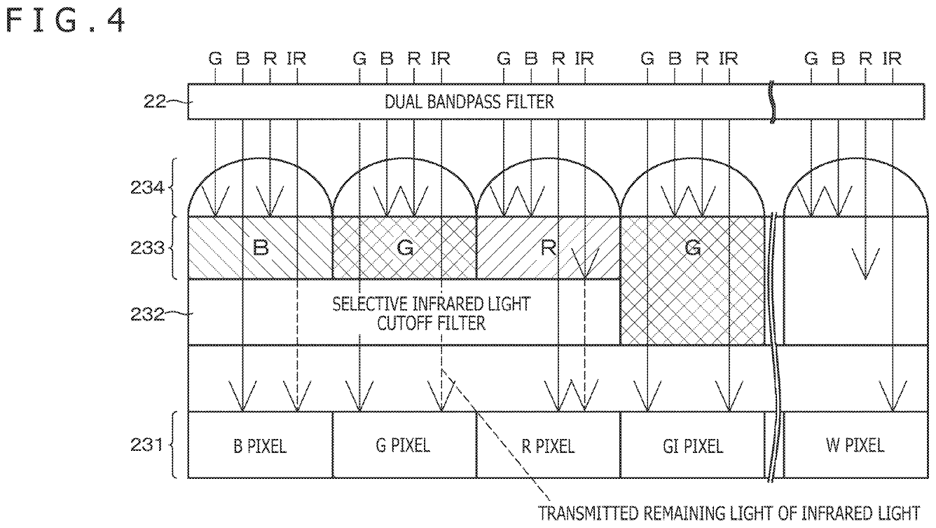

The configuration of a filter of each pixel of the pixel array section on which a matrix of pixels is arranged is illustrated in FIG. 4. FIG. 4 is a cross-sectional view of a B pixel, a G pixel, an R pixel, and a GI pixel taken along the line X-X in FIG. 3A and is a cross-sectional view of a W pixel.

Here, the GI pixel is a G pixel not having a selective infrared light cutoff filter formed thereon. Hereinafter, G pixels not having selective infrared light cutoff filters formed thereon are denoted as GI pixels. The GI pixels are pixels that are sensitive to two wavelength bands which are the G wavelength band and the infrared light wavelength band that is transmitted through the dual bandpass filters 22.

One example of spectral characteristics of the selective infrared light cutoff filters is illustrated in FIG. 3B. Although the transmittance of infrared light around 850 nm is approximately 12% in the spectral characteristics illustrated in FIG. 3B, the transmittance tends to vary within a surface of the image-capturing apparatus 23 or vary over time.

On the B pixel, the G pixel, and the R pixel in a pixel array section 231, infrared light cutoff filters to cut off infrared light (IR), for example, selective infrared light cutoff filters 232 that have characteristics of absorbing a wavelength area almost the same as the wavelength band of the produced infrared light from the light source, that is, the first infrared light wavelength band, and that limit the transmission of the first wavelength band are formed. Then, a color filter 233 corresponding to each pixel is formed on a selective infrared light cutoff filter 232.

The selective infrared light cutoff filter 232 to limit the transmission of the first infrared light wavelength band is not formed on the GI pixel, and only a G color filter is formed. The W pixel does not have a color filter formed thereon, but is sensitive to all the bands including infrared light and visible light corresponding to the sensitivity of a silicon substrate itself. Then, an on-chip lens 234 is formed for each pixel at the uppermost section of each pixel of the pixel array section 231.

In the color filter array according to the first example described above, the R, G, and B pixels are the first, second, and third pixels having the selective infrared light cutoff filters 232 as well as filters that transmit wavelength bands corresponding to the first color light (red light), the second color light (green light), and the third color light (blue light), respectively, that are visible light. The W pixel is the fourth pixel having transmission characteristics of transmitting the infrared light wavelength band. The GI pixel is the fifth pixel having wavelength transmission characteristics that are different from all of the first pixel, the second pixel, the third pixel, and the fourth pixel.

On the premise that the color filter array (pixel array) described above is used, optical signals to enter the individual pixels forming the unit pixel array are classified into five types which are R, G, B, IR, and kIR, corresponding to the layer configuration of the color filters. Here, kIR means infrared light having been transmitted through the selective infrared light cutoff filters 232, and its strength is the product of the strength IR of the infrared light and the infrared light transmittance k.

In addition, if the signal strength produced by the individual pixels when those types of light are received are Rᵢ, Gᵢ, Bᵢ, Wᵢ, and GIᵢ, the relation between the signal types described above and input signals of individual color components is expressed by a matrix calculation (transformation matrix A) like the one illustrated in the following Formula (3).

$$( \begin{matrix}{R}_{i} \\ {G}_{i} \\ {B}_{i} \\ {GI}_{i} \\ {W}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 0 & 1 & 0 & 0 & 1 \\ 1 & 1 & 1 & 0 & 1\end{matrix} ) ( \begin{matrix}R \\ G \\ B \\ kIR \\ IR\end{matrix} ) \\ {R}_{i} = R + kIR \\ {G}_{i} = G + kIR \\ {B}_{i} = B + kIR \\ {GI}_{i} = G + IR \\ {W}_{i} = R + G + B + IR \qquad ( 3 )$$

Note that, although the transformation matrix A simply includes lines of 1 and 0 for simplification of the explanation, specifically, it is also possible to describe components by using real numbers on the basis of the spectral characteristics of each filter. This also applies to each example mentioned below.

Here, a difference from the R-G-B-W color filter array (see FIG. 2B) according to the conventional example mentioned earlier is that there is an additional type of pixel, i.e., the GI pixel, and corresponding to this, by setting the strength of kIR also as an unknown coefficient, the transformation matrix A of entrance signal strength and pixel signals has five rows×five columns. As a result, if there is an inverse matrix of the transformation matrix A (determinant detA≠0), it becomes possible to compute the signal values of R, G, B, IR, and kIR that are separated from five types of entrance signal values by performing an inverse matrix calculation.

In the following Formula (4) illustrated, the inverse matrix of the transformation matrix A is actually determined to give a calculation formula for separating the individual entrance signal strength of R, G, B, kIR, and IR from pixel signals. In this configuration, computations of the individual signal strength are possible because there is the inverse matrix (determinant detA=2) of the transformation matrix A. Thereby, it becomes possible to determine, for each unit pixel array, also the infrared light transmittance k of a selective infrared light cutoff filter 232.

$$( \begin{matrix}R \\ G \\ B \\ kIR \\ IR\end{matrix} ) = \frac{1}{2} \times ( \begin{matrix}1 & 0 & - 1 & - 1 & 1 \\ - 1 & 2 & - 1 & - 1 & 1 \\ 1 & 0 & 1 & - 1 & 1 \\ 1 & 0 & 1 & 1 & - 1 \\ 1 & - 2 & 1 & 3 & - 1\end{matrix} ) ( \begin{matrix}{R}_{i} \\ {G}_{i} \\ {B}_{i} \\ {GI}_{i} \\ {W}_{i}\end{matrix} ) \\ R = 1 / 2 \times ( {R}_{i} - {B}_{i} - {GI}_{i} + {W}_{i} ) \\ G = 1 / 2 \times ( - {R}_{i} + 2 {G}_{1} - {B}_{i} - {GI}_{i} + {W}_{i} ) \\ B = 1 / 2 \times ( - {R}_{i} + {B}_{i} - {GI}_{i} + {W}_{i} ) \\ kIR = 1 / 2 \times ( {R}_{i} + {B}_{i} + {GI}_{i} - {W}_{i} ) \\ IR = 1 / 2 \times ( {R}_{i} - 2 {G}_{i} + {B}_{i} + 3 {GI}_{i} - {W}_{i} ) \qquad ( 4 )$$

According to the first example mentioned above, it is possible to determine, for each unit pixel array, also the infrared light transmittance k of a selective infrared light cutoff filter or the infrared light component kIR multiplied by the infrared light transmittance k, and accordingly it becomes possible to perform computations for separation between visible light and infrared light components more precisely without being influenced by spatial or temporal variations of the infrared light transmittance k of the selective infrared light cutoff filters, which has been a problem of the R-G-B-W color filter array according to the conventional example mentioned earlier. In addition, it becomes possible to avoid also the problem of the R-G-B-W color filter array according to the conventional example that solutions diverge.

### Modification Example of First Example

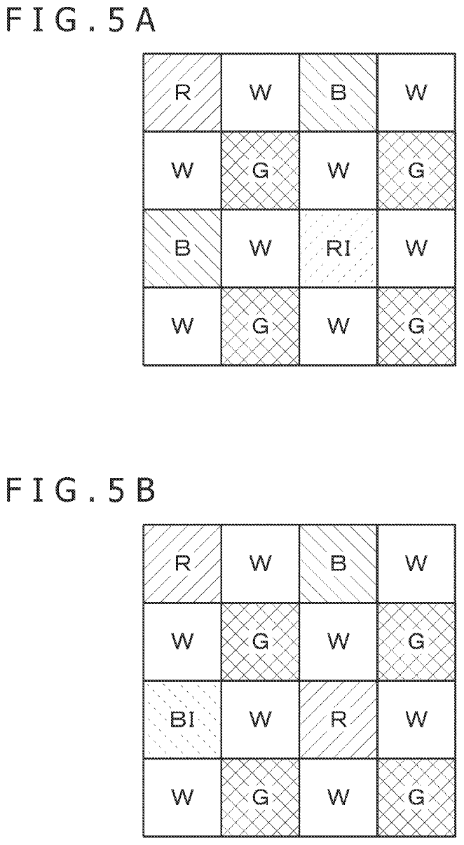

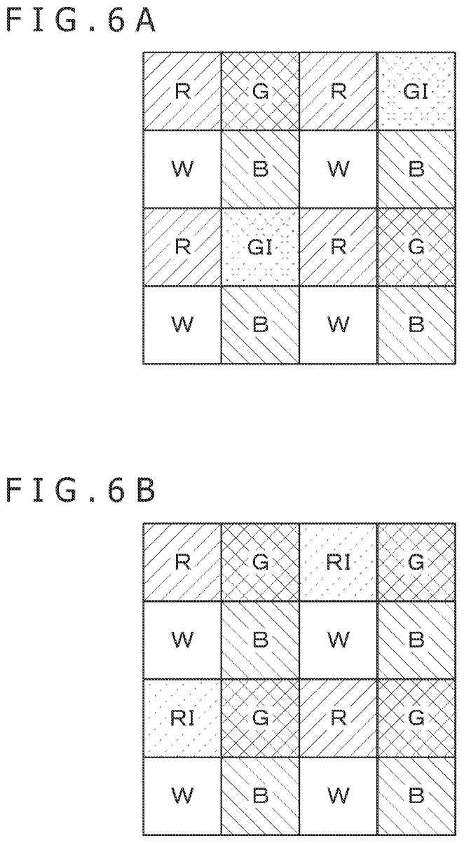

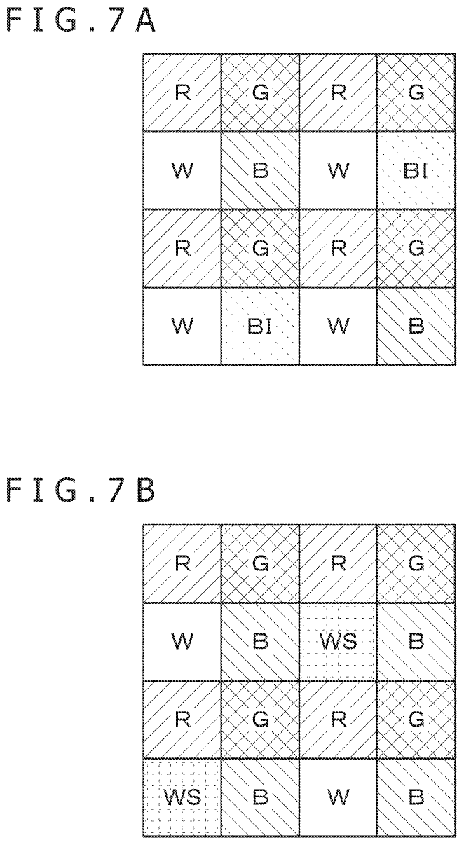

Advantages similar to those of the color filter array according to the first example can also be attained with other arrays as long as pixels of individual colors included in a unit pixel array (including IR (infrared light) and pixels that transmit all types of light (W)) include pixels having and not having selective infrared light cutoff filters and the transformation matrix corresponding to Formula (3) of the pixels has an inverse matrix (determinant det≠0). Modification examples of color filter arrays including repetitively arranged four rows×four columns are illustrated in FIG. 5A and FIG. 5B, and modification examples of color filter arrays including repetitively arranged two rows×two columns are illustrated in FIG. 6A, FIG. 6B, FIG. 7A, and FIG. 7B.

### First Modification Example

A color filter array according to a first modification example of the first example is illustrated in FIG. 5A. The color filter array according to the first modification example has a configuration which is similar to the color filter array (see FIG. 3A) according to the first example, but is different in that GI pixels are replaced with G pixels and an R pixel in the third row of the third column is replaced with an RI pixel not having a selective infrared light cutoff filter formed thereon. The RI pixel is an R pixel that is sensitive to two wavelength bands which are the R wavelength band and the infrared light wavelength band that is transmitted through the dual bandpass filter 22.

### Second Modification Example

A color filter array according to a second modification example of the first example is illustrated in B. The color filter array according to the second modification example has a configuration which is similar to the color filter array (see FIG. 3A) according to the first example, but is different in that GI pixels are replaced with G pixels and a B pixel in the third row of the first column is replaced with a BI pixel not having a selective infrared light cutoff filter formed thereon. The BI pixel is a B pixel that is sensitive to two wavelength bands which are the B wavelength band and the infrared light wavelength band that is transmitted through the dual bandpass filter 22.

### Third Modification Example

A color filter array according to a third modification example of the first example is illustrated in FIG. 6A. The color filter array according to the third modification example has a unit pixel array configuration in which two-rows×two-columns R-W-G-B pixel units and two-rows×two-columns R-W-GI-B pixel units are arranged alternately. The GI pixels are pixels that are sensitive to two wavelength bands which are the G wavelength band and the infrared light wavelength band that is transmitted through the dual bandpass filters 22.

### Fourth Modification Example

A color filter array according to a fourth modification example of the first example is illustrated in FIG. 6B. The color filter array according to the fourth modification example has a unit pixel array configuration in which two-rows×two-columns R-W-G-B pixel units and two-rows×two-columns RI-W-G-B pixel units are arranged alternately. The RI pixels are R pixels that are sensitive to two wavelength bands which are the R wavelength band and the infrared light wavelength band that is transmitted through the dual bandpass filters 22.

### Fifth Modification Example

A color filter array according to a fifth modification example of the first example is illustrated in FIG. 7A. The color filter array according to the fifth modification example has a unit pixel array configuration in which two-rows×two-columns R-W-G-B pixel units and two-rows×two-columns R-W-G-BI pixel units are arranged alternately. The BI pixels are B pixels that are sensitive to two wavelength bands which are the B wavelength band and the infrared light wavelength band that is transmitted through the dual bandpass filters 22.

### Sixth Modification Example

A color filter array according to a sixth modification example of the first example is illustrated in FIG. 7B. The color filter array according to the sixth modification example has a unit pixel array configuration in which two-rows×two-columns R-W-G-B pixel units and two-rows×two-columns R-WS-G-B pixel units are arranged alternately. The WS pixels are W pixels having selective infrared light cutoff filters formed thereon.

### Second Example

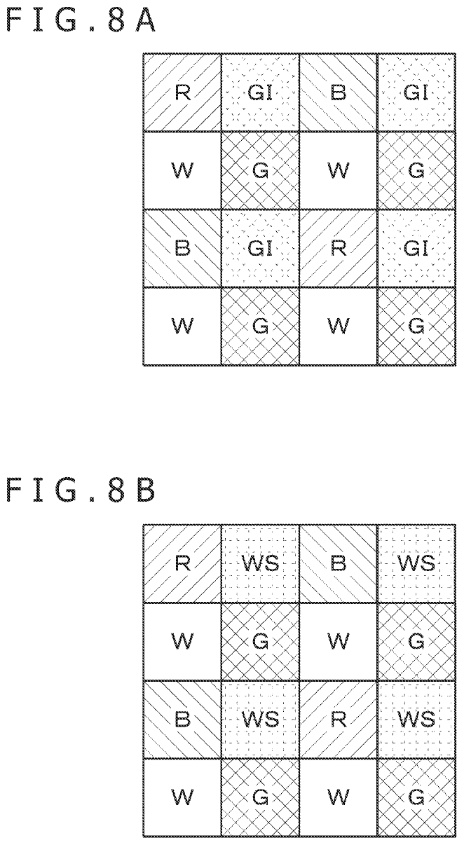

The second example is an example of a color filter array based on the R-G-B-W pixel array in which half of W pixels are replaced with GI pixels that are sensitive to two wavelength bands that are the G wavelength band and the infrared light wavelength band that is transmitted through the dual bandpass filters 22. The color filter array according to the second example is illustrated in FIG. 8A.

As illustrated in FIG. 8A, in the color filter array according to the second example, a four-rows×four-columns pixel array has a configuration including the following: the first row including an R pixel, a GI pixel, a B pixel, and a GI pixel; the second row and the fourth row each including a W pixel, a G pixel, a W pixel, and a G pixel; and the third row including a G pixel, a GI pixel, an R pixel, and a GI pixel. Here, the R pixels, the G pixels, and the B pixels are pixels having selective infrared light cutoff filters formed thereon, and the GI pixels and the W pixels are pixels not having selective infrared light cutoff filters formed thereon. The transformation matrix calculation formula of the color filter array according to the second example is the same as that in the case of the first example.

In the first example, half of G pixels are replaced with GI pixels. In the case of the first example, when the strength of the infrared light is high, noise of G signals computed from the GI pixels increases, and accordingly the quality of color images is influenced in some cases. In contrast, in the color filter array according to the second example, the color filter configuration of the R, G, and B pixels is similar to that in the R-G-B-W color filter array (see FIG. 2B) according to the conventional example, and accordingly the quality of color images can be kept at the same level even when the strength of the infrared light is high.

According to the second example mentioned above, in addition to that it becomes possible, similarly to the case of the first example, to perform computations for separation between visible light and infrared light components more precisely without being influenced by spatial or temporal variations of the transmittance k of selective infrared light cutoff filters, it becomes possible to keep the quality of color images at the same level even when the strength of the infrared light is high.

### Modification Example of Second Example

A color filter array according to a modification example of the second example is illustrated in FIG. 8B. The color filter array according to the modification example of the second example is an example in which half of W pixels in a color filter array including repetitively arranged four rows×four columns based on the R-G-B-W pixel array are replaced with WS pixels, which are W pixels having selective infrared light cutoff filters 232 formed thereon.

In the color filter array according to the modification example of the second example, if the strength of each signal produced by the individual pixels are Rᵢ, Gᵢ, Bᵢ, WSᵢ, or Wᵢ, the relation between the strength of each color component and the signal strength of each pixel is expressed by a matrix calculation like the one illustrated in the following Formula (5).

$$( \begin{matrix}{R}_{i} \\ {G}_{i} \\ {B}_{i} \\ {WS}_{i} \\ {W}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 1 & 1 & 1 & 1 & 0 \\ 1 & 1 & 1 & 0 & 1\end{matrix} ) ( \begin{matrix}R \\ G \\ B \\ kIR \\ IR\end{matrix} ) \qquad ( 5 )$$

Then, as illustrated in the following Formula (6), by determining an inverse matrix of the transformation matrix and performing an inverse transformation, it becomes possible to perform a separation computation of each signal component of R, G, B, kIR, or IR from the signal strength of each pixel.

$$( \begin{matrix}R \\ G \\ B \\ kIR \\ IR\end{matrix} ) = \frac{1}{2} \times ( \begin{matrix}1 & - 1 & - 1 & 1 & 0 \\ - 1 & 1 & - 1 & 1 & 0 \\ - 1 & - 1 & 1 & 1 & 0 \\ 1 & 1 & 1 & - 1 & 0 \\ 1 & 1 & 1 & - 3 & 2\end{matrix} ) ( \begin{matrix}{R}_{i} \\ {G}_{i} \\ {B}_{i} \\ {WS}_{i} \\ {W}_{i}\end{matrix} ) \qquad ( 6 )$$

In the color filter array according to the second example, the sensitivity to the components of visible light (R, B) lowers undesirably because half of W pixels are replaced with GI pixels. In contrast, in the color filter array according to the modification example of the second example, it becomes possible to maintain the sensitivity to the components of visible light (R, G, B) because half of W pixels are replaced with WS pixels.

### Third Example

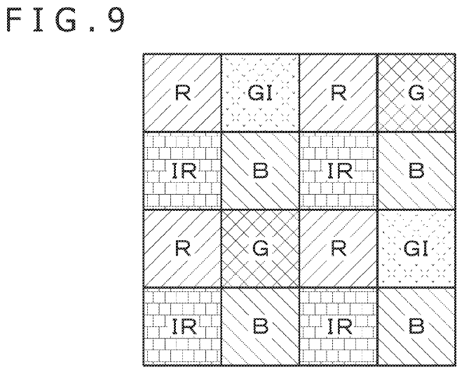

A third example is an example of a color filter array including repetitively arranged two rows×two columns based on the R-G-B-IR (infrared light) pixel array. The color filter array according to the third example is illustrated in FIG. 9.

A difference of the color filter array according to the third example from the color filter array according to the first example is that there are no W pixels as is apparent from FIG. 9. That is, the pixel array in the third example is a pixel array in which W pixels are replaced with IR pixels, and, by using the four-rows×four-columns pixel array as a unit, each filter is repetitively deployed on an individual pixel of the pixel array section. The IR pixels are pixels having transmission characteristics of transmitting the infrared light wavelength band.

The color filter array according to the third example has a configuration in which a selective infrared light cutoff filter is formed on each R, G, or B pixel, selective infrared light cutoff filters are formed on two G pixels in four G pixels in the color filter array, and selective infrared light cutoff filters are not formed on the two other G pixels (i.e., GI pixels).

Specifically, as illustrated in FIG. 9, in the third example, the four-rows×four-columns pixel array has a configuration including the following: the first row including an R pixel, a GI pixel, an R pixel, and a G pixel; the second row and the fourth row each including an IR pixel, a B pixel, an IR pixel, and a B pixel; and the third row including an R pixel, a G pixel, an R pixel, and a GI pixel. Here, the R pixels, the G pixels, the B pixels, and the IR pixels are pixels having selective infrared light cutoff filters formed thereon, and the GI pixels are pixels not having selective infrared light cutoff filters formed thereon.

In the color filter array according to the third example described above, the R, G, and B pixels are the first, second, and third pixels, respectively, having selective infrared light cutoff filters, and filters that transmit wavelength bands corresponding to the first color light (red light), the second color light (green light), and the third color light (blue light), respectively, that are visible light. The IR pixels are the fourth pixels having transmission characteristics of transmitting the infrared light wavelength band. The GI pixels are the fifth pixels having wavelength transmission characteristics that are different from all of the first pixels, the second pixels, the third pixels, and the fourth pixels.

In the color filter array according to the third example, if the strength of each signal produced by the individual pixels is Rᵢ, Gᵢ, Bᵢ, GIᵢ, or IRᵢ, the relation between the strength of each color component and the signal strength of each pixel is expressed by a matrix calculation like the one illustrated in the following Formula (7). Similarly to the case of the first example, by setting kIR, which is the product of the infrared light transmittance k of selective infrared light cutoff filters and the strength of the infrared light, as an unknown value, a five-rows×five-columns transformation formula is obtained.

$$( \begin{matrix}{R}_{i} \\ {G}_{i} \\ {B}_{i} \\ {GI}_{i} \\ {IR}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 0 & 1 & 0 & 0 & 1 \\ 0 & 0 & 0 & 0 & 1\end{matrix} ) ( \begin{matrix}R \\ C \\ B \\ kIR \\ IR\end{matrix} ) \qquad ( 7 )$$

Then, as illustrated in the following Formula (8), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = ( \begin{matrix}1 & - 1 & 0 & 1 & - 1 \\ 0 & 0 & 0 & 1 & - 1 \\ 0 & - 1 & 1 & 1 & - 1 \\ 0 & 1 & 0 & - 1 & 1 \\ 0 & 0 & 0 & 0 & 1\end{matrix} ) ( \begin{matrix}{R}_{i} \\ {G}_{i} \\ {B}_{i} \\ {GI}_{i} \\ {IR}_{i}\end{matrix} ) \qquad ( 8 )$$

Also in the third example based on the R-G-B-IR pixel array mentioned above, effects and advantages similar to those in the case of the first example based on the R-G-B-W pixel array can be attained. That is, it is possible to determine, for each unit pixel array, also the infrared light transmittance k of a selective infrared light cutoff filter or the infrared light component kIR multiplied by the infrared light transmittance k, and accordingly it becomes possible to perform computations for separation between visible light and infrared light components more precisely without being influenced by spatial or temporal variations of the infrared light transmittance k of the selective infrared light cutoff filters.

### Modification Example of Third Example

Advantages similar to those of the color filter array according to the third example can also be attained with other arrays as long as pixels of individual colors included in a unit pixel array (including IR (infrared light) pixels) include pixels having and not having selective infrared light cutoff filters and the transformation matrix corresponding to Formula (7) of the pixels has an inverse matrix (determinant det≠0).

### First Modification Example

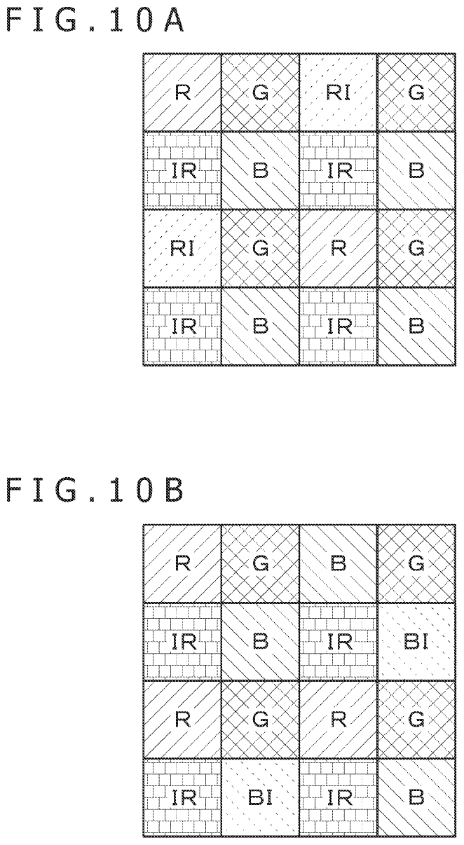

A color filter array according to a first modification example of the third example is illustrated in FIG. 10A. The color filter array according to the first modification example has a configuration which is similar to the color filter array (see FIG. 9) according to the third example, but is different in that R pixels in the third row of the first column and in the first row of the third column are replaced with RI pixels not having selective infrared light cutoff filters formed thereon, that is, RI pixels that are sensitive to two wavelength bands which are the R wavelength band and the infrared light wavelength band that is transmitted through the dual bandpass filters 22.

### Second Modification Example

A color filter array according to a second modification example of the third example is illustrated in FIG. 10B. The color filter array according to the second modification example has a configuration which is similar to the color filter array (see FIG. 9) according to the third example, but is different in that B pixels in the fourth row of the second column and in the second row of the fourth column are replaced with BI pixels not having selective infrared light cutoff filters formed thereon, that is, BI pixels that are sensitive to two wavelength bands which are the B wavelength band and the infrared light wavelength band that is transmitted through the dual bandpass filters 22.

### Fourth Example

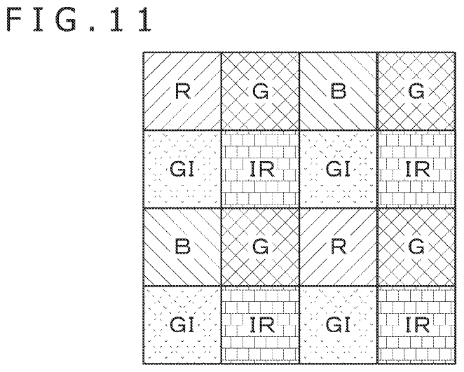

A fourth example is an example in which the number of G pixels that are more advantageous in terms of resolution is increased in a color filter array including repetitively arranged four rows×four columns based on the R-G-B-IR pixel array, and the numbers of R pixels and B pixels that are less advantageous in terms of resolution are reduced. The color filter array according to the fourth example is illustrated in FIG. 11.

As illustrated in FIG. 11, an R-G-B-IR pixel array in the fourth example has a configuration in which eight, which is half, of the total of 16 pixels in four rows×four columns are G pixels, four G pixels in the eight G pixels have the selective infrared light cutoff filters formed thereon, and the other four G pixels do not have the selective infrared light cutoff filters formed thereon. Then, it becomes possible to compute a signal value of each filter by a transformation formula similar to that in the case of the third example.

Specifically, the four-rows×four-columns pixel array has a configuration including the following: the first row including an R pixel, a G pixel, a B pixel, and a G pixel; the second row and the fourth row each including a GI pixel, an IR pixel, a GI pixel, and an IR pixel; and the third row including a B pixel, a G pixel, an R pixel, and a G pixel. Here, the R pixels, the G pixels, the B pixels, and the IR pixels are pixels having selective infrared light cutoff filters formed thereon, and the GI pixels are pixels not having selective infrared light cutoff filters formed thereon.

According to the fourth example mentioned above, effects and advantages similar to those in the case of the third example can be attained because it is based on the R-G-B-IR pixel array. In addition to those effects and advantages, in the fourth example, it is possible to seek increased resolution because the number of G pixels that are more advantageous in terms of resolution is greater than the numbers of R pixels and B pixels.

### Modification Example of Fourth Example

Advantages similar to those of the color filter array according to the fourth example can also be attained with other arrays as long as pixels of individual colors included in a unit pixel array (including IR (infrared light) pixels) include pixels having and not having selective infrared light cutoff filters and the transformation matrix corresponding to Formula (7) of the pixels has an inverse matrix (determinant det≠0).

### First Modification Example

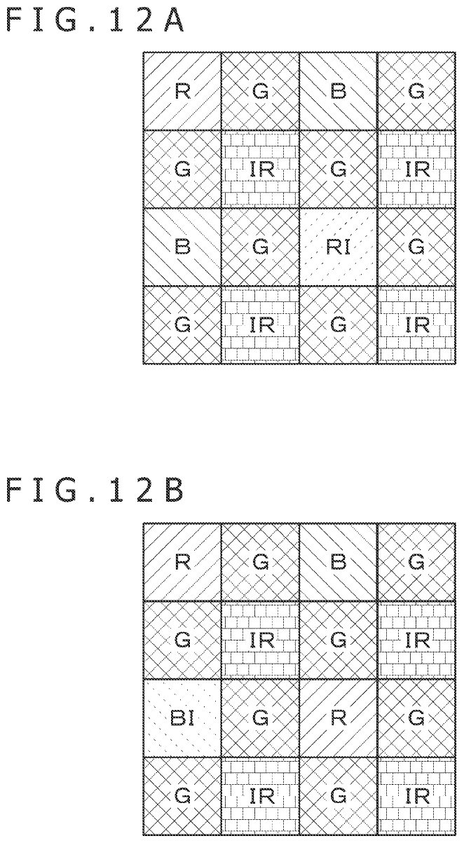

A color filter array according to a first modification example of the fourth example is illustrated in FIG. 12A. The color filter array according to the first modification example has a configuration which is similar to the color filter array (see FIG. 11) according to the fourth example, but is different in that GI pixels are replaced with G pixels and an R pixel in the third row of the third column is replaced with an RI pixel not having a selective infrared light cutoff filter formed thereon.

### Second Modification Example

A color filter array according to a second modification example of the fourth example is illustrated in FIG. 12B. The color filter array according to the first modification example has a configuration which is similar to the color filter array (see FIG. 11) according to the fourth example, but is different in that GI pixels are replaced with G pixels and a B pixel in the third row of the first column is replaced with a GI pixel not having a selective infrared light cutoff filter formed thereon.

### Fifth Example

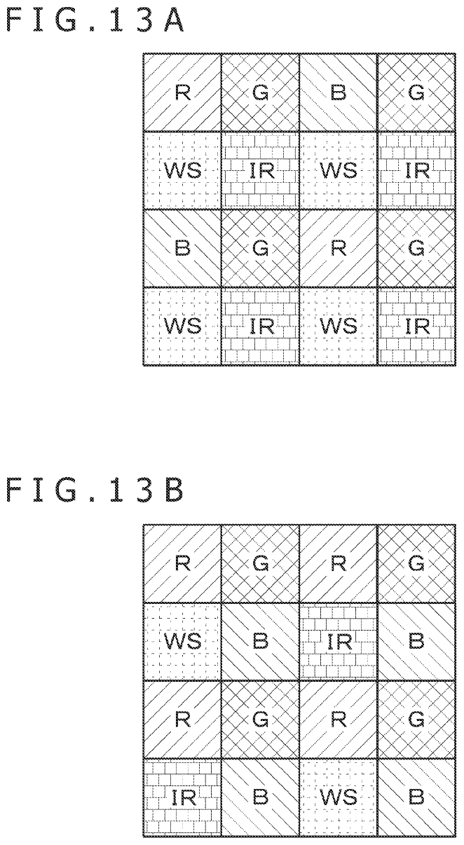

A fifth example is an example in which half of G pixels in a color filter array including repetitively arranged four rows×four columns based on the R-G-B-IR pixel array are replaced with WS pixels which have selective infrared light cutoff filters formed thereon. The color filter array according to the fifth example is illustrated in FIG. 13A.

As illustrated in FIG. 13A, the color filter array according to the fifth example has a configuration in which half of G pixels in the R-G-B-IR pixel array are replaced with WS pixels and four G pixels, four WS pixels, and four IR pixels are arranged. Specifically, the four-rows×four-columns pixel array has a configuration including the following: the first row including an R pixel, a G pixel, a B pixel, and a G pixel; the second row and the fourth row each including a WS pixel, an IR pixel, a WS pixel, and an IR pixel; and the third row including a B pixel, a G pixel, an R pixel, and a G pixel. The WS pixels are W pixels having selective infrared light cutoff filters formed thereon.

In the color filter array according to the fifth example described above, the R, G, and B pixels are the first, second, and third pixels, respectively, having selective infrared light cutoff filters, and filters that transmit wavelength bands corresponding to the first color light (red light), the second color light (green light), and the third color light (blue light), respectively, that are visible light. The IR pixels are the fourth pixels having transmission characteristics of transmitting the infrared light wavelength band. The WS pixels are the fifth pixels having wavelength transmission characteristics that are different from all of the first pixels, the second pixels, the third pixels, and the fourth pixels.

In the color filter array according to the fifth example, if the strength of each signal produced by the individual pixels is WSᵢ, or IRᵢ, the relation between the strength of each color component and the signal strength of each pixel is expressed by a matrix calculation like the one illustrated in the following Formula (9).

$$( \begin{matrix}{R}_{i} \\ {G}_{i} \\ {B}_{i} \\ {WS}_{i} \\ {IR}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 1 & 1 & 1 & 1 & 0 \\ 0 & 0 & 0 & 0 & 1\end{matrix} ) ( \begin{matrix}R \\ G \\ B \\ k I R \\ I R\end{matrix} ) \qquad ( 9 )$$

Then, as illustrated in the following Formula (10), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = \frac{1}{2} \times ( \begin{matrix}1 & - 1 & - 1 & 1 & 0 \\ - 1 & 1 & - 1 & 1 & 0 \\ - 1 & - 1 & 1 & 1 & 0 \\ 1 & 1 & 1 & - 1 & 0 \\ 0 & 0 & 0 & 0 & 2\end{matrix} ) ( \begin{matrix}{R}_{i} \\ {G}_{i} \\ {B}_{i} \\ {WS}_{i} \\ {IR}_{i}\end{matrix} ) \qquad ( 10 )$$

According to the fifth example mentioned above also, effects and advantages similar to those in the case of the third example can be attained because it is based on the R-G-B-IR pixel array. In addition, in the case of the fifth example, although the resolution of infrared light decreases as compared with the fourth example because half of G pixels are replaced with WS pixels, it is possible to seek improved sensitivity to visible light.

### Modification Example of Fifth Example

A color filter array according to a modification example of the fifth example is illustrated in FIG. 13B. As illustrated in FIG. 13B, the modification example of the fifth example is different from the pixel array of the fifth example (FIG. 13A) in terms of the color arrays in the second row and the fourth row. Specifically, in the pixel array of the fifth example, the second row and the fourth row each have an array of a WS pixel, an IR pixel, a WS pixel, and an IR pixel. In contrast, in the pixel array of the modification example of the fifth example, the second row has an array of a WS pixel, a B pixel, an IR pixel, and a B pixel, and the fourth row has an array of an IR pixel, a B pixel, a WS pixel, and a B pixel.

### Sixth Example

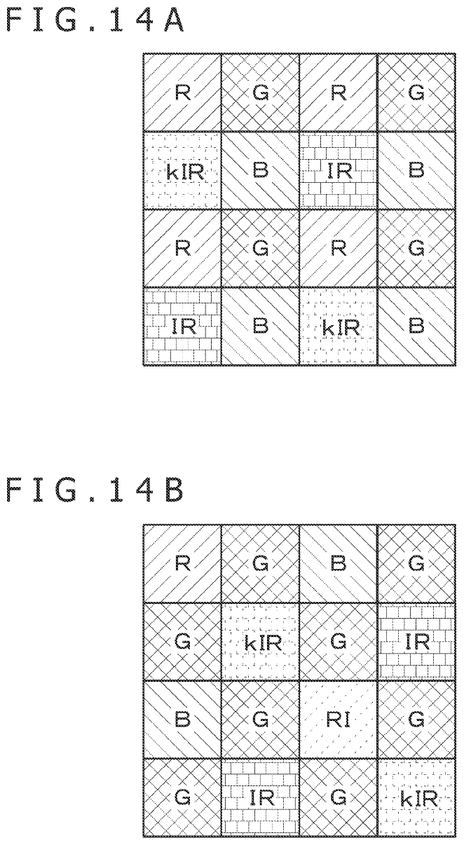

A sixth example is an example in which half of IR pixels in a color filter array based on the R-G-B-IR pixel array are replaced with kIR pixels which are IR pixels having selective infrared light cutoff filters formed thereon. The color filter array according to the sixth example is illustrated in FIG. 14A.

The color filter array according to the sixth example has a configuration in which a four-rows×four-columns pixel array includes the following: the first row and the third row each including an R pixel, a G pixel, a B pixel, and a G pixel; the second row including a kIR pixel, a B pixel, an IR pixel, and a B pixel; and the fourth row including an IR pixel, a kIR pixel, an R pixel, and a B pixel.

In the color filter array according to the sixth example described above, the R, G, and B pixels are the first, second, and third pixels, respectively, having selective infrared light cutoff filters, and filters that transmit wavelength bands corresponding to the first color light (red light), the second color light (green light), and the third color light (blue light), respectively, that are visible light. The IR pixels are the fourth pixels having transmission characteristics of transmitting the infrared light wavelength band. The kIR pixels are the fifth pixels having wavelength transmission characteristics that are different from all of the first pixels, the second pixels, the third pixels, and the fourth pixels.

In the color filter array according to the sixth example, if the strength of each signal produced by the individual pixels is Rᵢ, Gᵢ, Bᵢ, kIRᵢ, or IRᵢ, the relation between the strength of each color component and the signal strength of each pixel is expressed by a matrix calculation like the one illustrated in the following Formula (11).

$$( \begin{matrix}{R}_{i} \\ {G}_{i} \\ {B}_{i} \\ {kIR}_{i} \\ {IR}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 0 & 0 & 0 & 1 & 0 \\ 0 & 0 & 0 & 0 & 1\end{matrix} ) ( \begin{matrix}R \\ G \\ B \\ k I R \\ I R\end{matrix} ) \qquad ( 11 )$$

Then, as illustrated in the following Formula (12), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = ( \begin{matrix}1 & 0 & 0 & - 1 & 0 \\ 0 & 1 & 0 & - 1 & 0 \\ 0 & 0 & 1 & - 1 & 0 \\ 0 & 0 & 0 & 1 & 0 \\ 0 & 0 & 0 & 0 & 1\end{matrix} ) ( \begin{matrix}{R}_{i} \\ {G}_{i} \\ {B}_{i} \\ {kIR}_{i} \\ {IR}_{i}\end{matrix} ) \qquad ( 12 )$$

According to the sixth example mentioned above also, effects and advantages similar to those in the case of the third example can be attained because it is based on the R-G-B-IR pixel array. In addition, although the resolution of infrared light deteriorates because half of IR pixels are replaced with kIR pixels, it becomes possible to compute the infrared light transmittance k of the selective infrared light cutoff filters by using the IR pixels and the kIR pixels.

### Modification Example of Sixth Example

A color filter array according to a modification example of the sixth example is illustrated in FIG. 14B.

The color filter array according to the present modification example has a configuration in which a four-rows×four-columns pixel array includes the following: the first row including an R pixel, a G pixel, a B pixel, and a G pixel; the second row including a G pixel, a kIR pixel, a G pixel, and an IR pixel; the third row including a B pixel, a G pixel, an IR pixel, and a G pixel; and the fourth row including a G pixel, an IR pixel, a G pixel, and a kIR pixel.

### Seventh Example

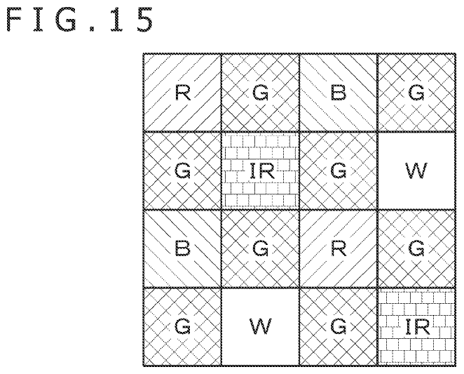

A seventh example is an example of a color filter array based on the R-G-B-W-IR pixel array. The color filter array according to the seventh example is illustrated in FIG. 15.

The color filter array according to the seventh example has a configuration in which half of IR pixels are replaced with W pixels in the R-G-B-IR pixel array according to the fourth example (see FIG. 11). Specifically, the color filter array according to the seventh example has a unit pixel array configuration in which two-rows×two-columns R-G-G-IR pixel units and two-rows×two-columns B-G-G-W pixel units are arranged alternately.

In the color filter array according to the seventh example, if the strength of each signal produced by the individual pixels is Rᵢ, Gᵢ, Bᵢ, Wᵢ, or IRᵢ, the relation between the strength of each color component and the signal strength of each pixel is expressed by a matrix calculation like the one illustrated in the following Formula (13).

$$( \begin{matrix}{R}_{i} \\ {G}_{i} \\ {B}_{i} \\ {W}_{i} \\ {IR}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 1 & 1 & 1 & 0 & 1 \\ 0 & 0 & 0 & 0 & 1\end{matrix} ) ( \begin{matrix}R \\ G \\ B \\ kIR \\ IR\end{matrix} ) \qquad ( 13 )$$

Then, as illustrated in the following Formula (14), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = \frac{1}{3} \times ( \begin{matrix}2 & - 1 & - 1 & 1 & - 1 \\ - 1 & 2 & - 1 & 1 & - 1 \\ - 1 & - 1 & 2 & 1 & - 1 \\ 1 & 1 & 1 & - 1 & 1 \\ 0 & 0 & 0 & 0 & 3\end{matrix} ) ( \begin{matrix}{R}_{i} \\ {G}_{i} \\ {B}_{i} \\ {W}_{i} \\ {IR}_{i}\end{matrix} ) \qquad ( 14 )$$

Also in the seventh example based on the R-G-B-W-IR pixel array mentioned above, effects and advantages similar to those in the case of the first example based on the R-G-B-W pixel array and the third example based on the R-G-B-IR pixel array can be attained. That is, it is possible to determine, for each unit pixel array, also the infrared light transmittance k of a selective infrared light cutoff filter or the infrared light component kIR multiplied by the infrared light transmittance k, and accordingly it becomes possible to perform computations for separation between visible light and infrared light components more precisely without being influenced by spatial or temporal variations of the infrared light transmittance k of the selective infrared light cutoff filters.

### Modification Example of Seventh Example

Advantages similar to those of the color filter array according to the seventh example can also be attained with other arrays as long as pixels of individual colors included in a unit pixel array (including IR pixels and W pixels) include pixels having and not having selective infrared light cutoff filters and the transformation matrix corresponding to Formula (13) of the pixels has an inverse matrix (determinant det≠0).

### First Modification Example

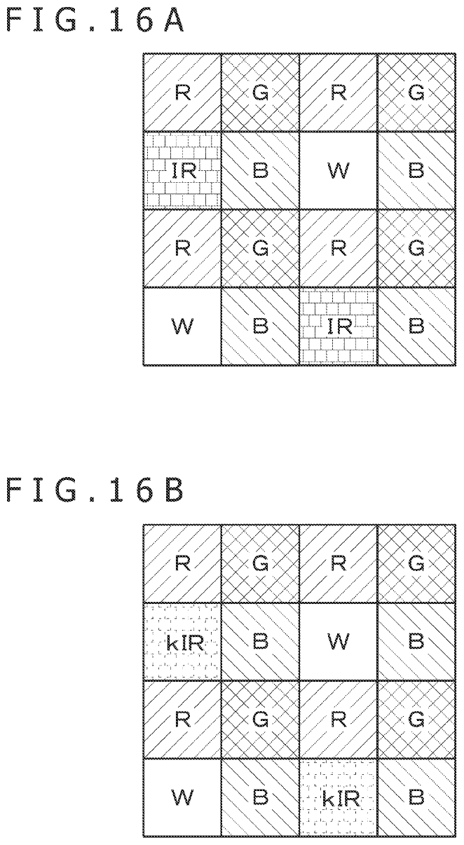

A color filter array according to a first modification example of the seventh example is illustrated in FIG. 16A. The color filter array according to the first modification example has a unit pixel array configuration in which two-rows×two-columns R-IR-G-B pixel units and two-rows×two-columns R-W-G-B pixel units are arranged alternately.

### Second Modification Example

A color filter array according to a second modification example of the seventh example is illustrated in FIG. 16B. The color filter array according to the second modification example has a unit pixel array configuration in which two-rows×two-columns R-kIR-G-B pixel units and two-rows×two-columns R-W-G-B pixel units are arranged alternately.

### Eighth Example

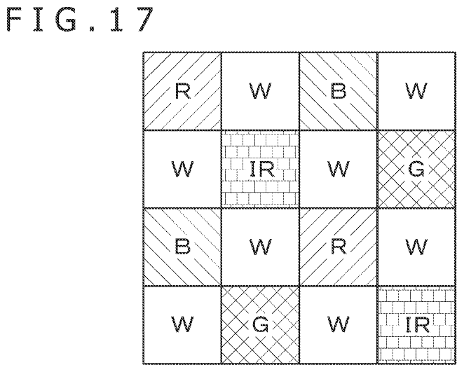

An eighth example is also an example of a color filter array based on the R-G-B-W-IR pixel array similarly to the seventh example. The color filter array according to the eighth example is illustrated in FIG. 17.

The color filter array according to the eighth example has a configuration in which half of G pixels in the R-G-B-W pixel array are replaced with IR pixels. Specifically, the color filter array according to the eighth example has a unit pixel array configuration in which two-rows×two-columns R-W-W-IR pixel units and two-rows×two-columns B-W-W-G pixel units are arranged alternately. The transformation matrix calculation formula of the color filter array according to the eighth example is the same as that in the case of the seventh example.

Also in the eighth example based on the R-G-B-W-IR pixel array mentioned above, effects and advantages similar to those in the case of the first example based on the R-G-B-W pixel array and the third example based on the R-G-B-IR pixel array can be attained. That is, it is possible to determine, for each unit pixel array, also the infrared light transmittance k of a selective infrared light cutoff filter or the infrared light component kIR multiplied by the infrared light transmittance k, and accordingly it becomes possible to perform computations for separation between visible light and infrared light components more precisely without being influenced by spatial or temporal variations of the infrared light transmittance k of the selective infrared light cutoff filters.

### Modification Example of Eighth Example

Advantages similar to those of the color filter array according to the eighth example can also be attained with other arrays as long as pixels of individual colors included in a unit pixel array (including IR pixels and W pixels) include pixels having and not having selective infrared light cutoff filters and the transformation matrix corresponding to Formula (13) of the pixels has an inverse matrix (determinant det≠0).

### First Modification Example

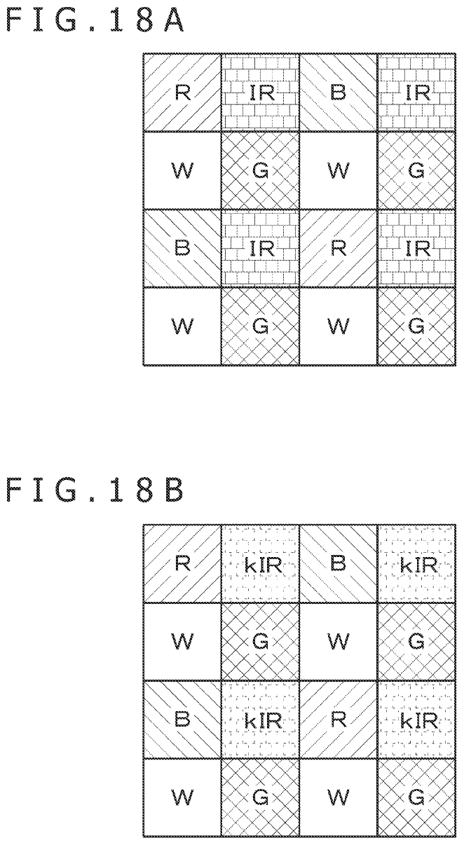

A color filter array according to a first modification example of the eighth example is illustrated in FIG. 18A. The color filter array according to the first modification example has a configuration in which IR pixels are replaced with G pixels and half of W pixels are replaced with IR pixels in the color filter array according to the eighth example (see FIG. 17). Specifically, the color filter array according to the first modification example has a unit pixel array configuration in which two-rows×two-columns R-W-IR-G pixel units and two-rows×two-columns B-W-IR-G pixel units are arranged alternately.

### Second Modification Example

A color filter array according to a second modification example of the seventh example is illustrated in FIG. 18B. The color filter array according to the second modification example has a configuration in which IR pixels are replaced with G pixels and half of W pixels are replaced with kIR pixels in the color filter array according to the eighth example (see FIG. 17). Specifically, the color filter array according to the second modification example has a unit pixel array configuration in which two-rows×two-columns R-W-kIR-G pixel units and two-rows×two-columns B-W-kIR-G pixel units are arranged alternately.

### Ninth Example

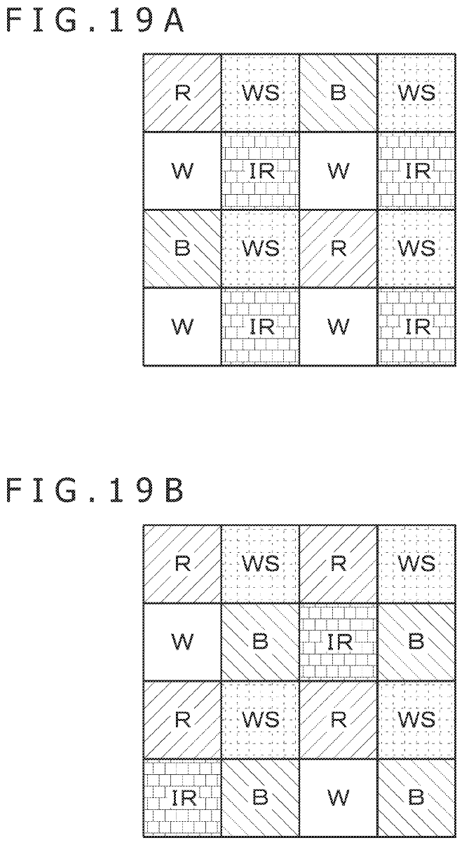

A ninth example is an example of a color filter array based on the R-B-W-WS-IR pixel array. The color filter array according to the ninth example is illustrated in FIG. 19A.

The color filter array according to the ninth example has a configuration in which G pixels are replaced with WS pixels, and GI pixels are replaced with W pixels in the color filter array according to the fourth example (see FIG. 11). Specifically, the color filter array according to the ninth example has a unit pixel array configuration in which two-rows×two-columns R-W-WS-IR pixel units and two-rows×two-columns B-W-WS-IR pixel units are arranged alternately. G signals are computed from other pixel signals.

In the color filter array according to the ninth example, if the strength of each signal produced by the individual pixels is Rᵢ, Bᵢ, WSᵢ, Wᵢ, or IRᵢ, the relation between the strength of each color component and the signal strength of each pixel is expressed by a matrix calculation like the one illustrated in the following Formula (15).

$$( \begin{matrix}{R}_{i} \\ {G}_{i} \\ {B}_{i} \\ {W}_{i} \\ {IR}_{i}\end{matrix} ) = ( \begin{matrix}1 & 0 & 0 & 1 & 0 \\ 0 & 0 & 1 & 1 & 0 \\ 1 & 1 & 1 & 1 & 0 \\ 1 & 1 & 1 & 0 & 1 \\ 0 & 0 & 0 & 0 & 1\end{matrix} ) ( \begin{matrix}R \\ G \\ B \\ k I R \\ I R\end{matrix} ) \qquad ( 15 )$$

Then, as illustrated in the following Formula (16), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = ( \begin{matrix}1 & 0 & - 1 & 1 & - 1 \\ - 1 & - 1 & 2 & - 1 & 1 \\ 0 & 1 & - 1 & 1 & - 1 \\ 0 & 0 & 1 & - 1 & 1 \\ 0 & 0 & 0 & 0 & 1\end{matrix} ) ( \begin{matrix}{R}_{i} \\ {G}_{i} \\ {B}_{i} \\ {W}_{i} \\ {IR}_{i}\end{matrix} ) \qquad ( 16 )$$

Also in the ninth example based on the R-B-W-WS-IR pixel array mentioned above, it is possible to determine, for each unit pixel array, also the infrared light transmittance k of a selective infrared light cutoff filter or the infrared light component kIR multiplied by the infrared light transmittance k. Accordingly, it becomes possible to perform computations for separation between visible light and infrared light components more precisely without being influenced by spatial or temporal variations of the infrared light transmittance k of the selective infrared light cutoff filters. In addition, because G pixels are replaced with WS pixels and GI pixels are replaced with W pixels, it is possible to seek improved sensitivity more than that in a case where such replacement is not performed.

### Modification Example of Ninth Example

Advantages similar to those of the color filter array according to the ninth example can also be attained with other arrays as long as pixels of individual colors included in a unit pixel array (including IR pixels and W pixels) include pixels having and not having selective infrared light cutoff filters and the transformation matrix corresponding to Formula (15) of the pixels has an inverse matrix (determinant det≠0).

### First Modification Example

A color filter array according to a first modification example of the ninth example is illustrated in FIG. 19B. The color filter array according to the first modification example has a unit pixel array configuration in which two-rows×two-columns R-W-WS-B pixel units and two-rows×two-columns R-IR-WS-B pixel units are arranged alternately.

### Second Modification Example

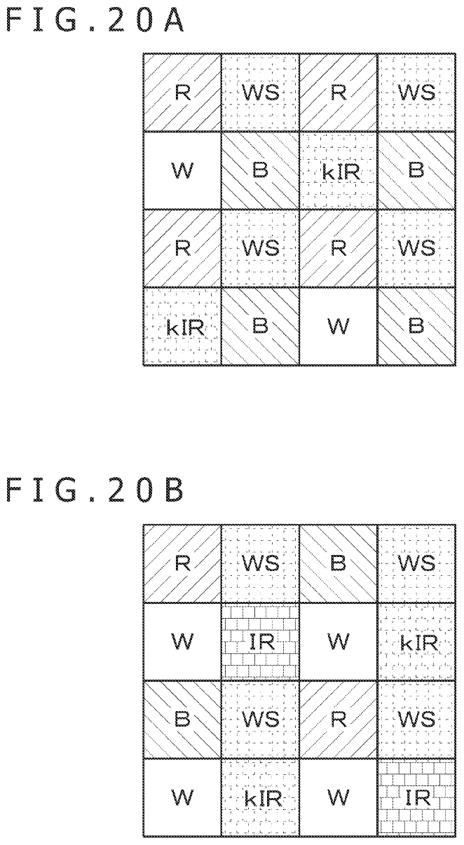

A color filter array according to a second modification example of the ninth example is illustrated in FIG. 20A. The color filter array according to the second modification example has a configuration in which IR pixels are replaced with kIR pixels in the color filter array according to the first modification example (see FIG. 19B). Specifically, the color filter array according to the second modification example has a unit pixel array configuration in which two-rows×two-columns R-W-WS-B pixel units and two-rows×two-columns R-kIR-WS-B pixel units are arranged alternately.

### Third Modification Example

A color filter array according to a third modification example of the ninth example is illustrated in FIG. 20B. The color filter array according to the third modification example has a configuration in which half of IR pixels are replaced with kIR pixels in the color filter array according to the ninth example (see FIG. 19A). Specifically, the color filter array according to the third modification example has a unit pixel array configuration in which two-rows×two-columns R-W-WS-IR pixel units and two-rows×two-columns B-W-WS-kIR pixel units are arranged alternately.

### Tenth Example

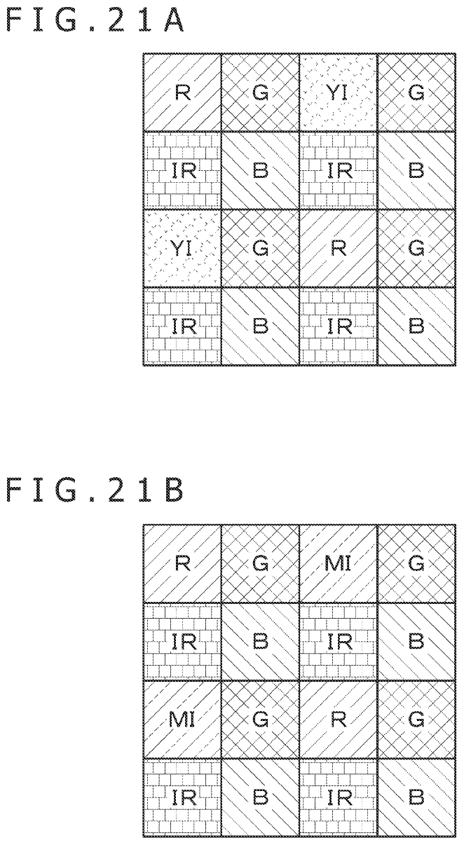

A tenth example is an example of a color filter array in which R, G, and B color filters are replaced with complementary color filters. Examples of the complementary color filters include Ye (yellow), Mg (magenta), and Cy (cyan) filters. The color filter array according to the tenth example is illustrated in FIG. 21A.

The color filter array according to the tenth example has a configuration in which half of R pixels in R, G, and B pixels are replaced with YI pixels in a color filter array based on the R-G-B-IR pixel array. Specifically, the color filter array according to the tenth example has a unit pixel array configuration in which two-rows×two-columns R-IR-G-B pixel units and two-rows×two-columns YI-IR-G-B pixel units are arranged alternately. Here, the YI pixels are Ye pixels not having selective infrared light cutoff filters formed thereon.

In the color filter array according to the tenth example described above, the R, G, and B pixels are the first, second, and third pixels, respectively, having selective infrared light cutoff filters 232 as well as filters that transmit wavelength bands corresponding to the first color light (red light), the second color light (green light), and the third color light (blue light), respectively, that are visible light. The IR pixels are the fourth pixels having transmission characteristics of transmitting the infrared light wavelength band. The YI pixels, which are complementary color pixels, are the fifth pixels having wavelength transmission characteristics that are different from all of the first pixels, the second pixels, the third pixels, and the fourth pixels.

In the color filter array according to the tenth example, if the strength of each signal produced by the individual pixels is Rᵢ, Gᵢ, Bᵢ, YIᵢ, or IRᵢ, the relation between the strength of each color component and the signal strength of each pixel is expressed by a matrix calculation like the one illustrated in the following Formula (17).

$$( \begin{matrix}{R}_{i} \\ {G}_{i} \\ {B}_{i} \\ {YI}_{i} \\ {IR}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 1 & 1 & 0 & 0 & 1 \\ 0 & 0 & 0 & 0 & 1\end{matrix} ) ( \begin{matrix}R \\ G \\ B \\ kIR \\ I R\end{matrix} ) \qquad ( 17 )$$

Then, as illustrated in the following Formula (18), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = \frac{1}{2} \times ( \begin{matrix}1 & - 1 & 0 & 1 & - 1 \\ - 1 & 1 & 0 & 1 & - 1 \\ - 1 & - 1 & 1 & 1 & - 1 \\ 1 & 1 & 0 & - 1 & 1 \\ 0 & 0 & 0 & 0 & 1\end{matrix} ) ( \begin{matrix}{R}_{i} \\ {G}_{i} \\ {B}_{i} \\ {YI}_{i} \\ {IR}_{i}\end{matrix} ) \qquad ( 18 )$$

In the tenth example in which half of R pixels are replaced with YI pixels also in the R-G-B-IR color filter array mentioned above, it is possible to determine, for each unit pixel array, also the infrared light transmittance k of a selective infrared light cutoff filter or the infrared light component kIR multiplied by the infrared light transmittance k. Accordingly, it becomes possible to perform computations for separation between visible light and infrared light components more precisely without being influenced by spatial or temporal variations of the infrared light transmittance k of the selective infrared light cutoff filters. In addition, by adopting a configuration using complementary color filters, it becomes possible to raise the sensitivity to visible light as compared with the case that R, G, and B color filters are used.

### Modification Example of Tenth Example

Advantages similar to those of the color filter array according to the tenth example can also be attained with other arrays as long as pixels of individual colors included in a unit pixel array (including IR pixels and YI pixels) include pixels having and not having selective infrared light cutoff filters and the transformation matrix corresponding to Formula (17) of the pixels has an inverse matrix (determinant det≠0).

### First Modification Example

A color filter array according to a first modification example of the tenth example is illustrated in FIG. 21B. The color filter array according to the first modification example has a configuration in which YI pixels are replaced with MI pixels in the color filter array according to the tenth example (see FIG. 21A). Specifically, the color filter array according to the first modification example has a unit pixel array configuration in which two-rows×two-columns R-IR-G-B pixel units and two-rows×two-columns MI-IR-G-B pixel units are arranged alternately. Here, MI pixels, which are complementary color pixels, are Mg pixels not having selective infrared light cutoff filters formed thereon, and are the fifth pixels having wavelength transmission characteristics that are different from all of the first pixels, the second pixels, the third pixels, and the fourth pixels.

### Second Modification Example

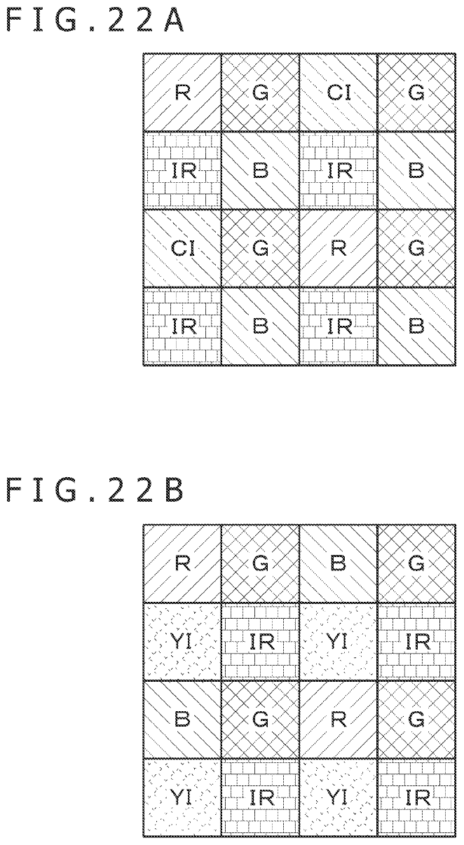

A color filter array according to a second modification example of the tenth example is illustrated in FIG. 22A. The color filter array according to the second modification example has a configuration in which YI pixels are replaced with CI pixels in the color filter array according to the tenth example (see FIG. 21A). Specifically, the color filter array according to the second modification example has a unit pixel array configuration in which two-rows×two-columns R-IR-G-B pixel units and two-rows×two-columns CI-IR-G-B pixel units are arranged alternately. Here, CI pixels, which are complementary color pixels, are Cy pixels not having selective infrared light cutoff filters formed thereon, and are the fifth pixels having wavelength transmission characteristics that are different from all of the first pixels, the second pixels, the third pixels, and the fourth pixels.

### Third Modification Example

A color filter array according to a third modification example of the tenth example is illustrated in FIG. 22B. The color filter array according to the third modification example has a configuration in which GI pixels are replaced with YI pixels in the color filter array according to the fourth example (see FIG. 11). Specifically, the color filter array according to the third modification example has a unit pixel array configuration in which two-rows×two-columns R-YI-G-IR pixel units and two-rows×two-columns B-YI-G-IR pixel units are arranged alternately.

### Fourth Modification Example

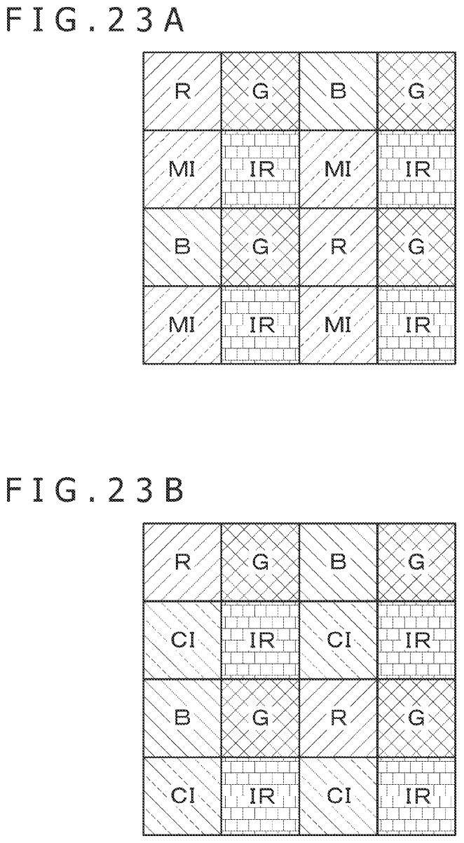

A color filter array according to a fourth modification example of the tenth example is illustrated in FIG. 23A. The color filter array according to the fourth modification example has a configuration in which GI pixels are replaced with MI pixels in the color filter array according to the fourth example (see FIG. 11). Specifically, the color filter array according to the fourth modification example has a unit pixel array configuration in which two-rows×two-columns R-MI-G-IR pixel units and two-rows×two-columns B-MI-G-IR pixel units are arranged alternately.

### Fifth Modification Example

A color filter array according to a fifth modification example of the tenth example is illustrated in FIG. 23B. The color filter array according to the fifth modification example has a configuration in which GI pixels are replaced with CI pixels in the color filter array according to the fourth example (see FIG. 11). Specifically, the color filter array according to the fifth modification example has a unit pixel array configuration in which two-rows×two-columns R-CI-G-IR pixel units and two-rows×two-columns B-CI-G-IR pixel units are arranged alternately.

### Eleventh Example

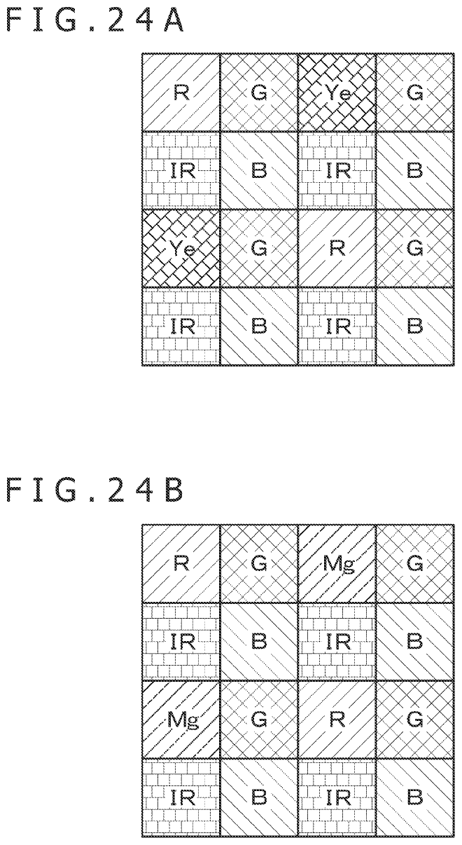

An eleventh example is an example in which half of R pixels in R, G, and B pixels are replaced with Ye pixels in a color filter array based on the R-G-B-IR pixel array. Here, the Ye pixels are pixels having selective infrared light cutoff filters formed thereon. The color filter array according to the eleventh example is illustrated in FIG. 24A.

The color filter array according to the eleventh example has a configuration in which YI pixels are replaced with Ye pixels in the color filter array according to the tenth example (see FIG. 21A). Specifically, the color filter array according to the eleventh example has a unit pixel array configuration in which two-rows×two-columns R-IR-G-B pixel units and two-rows×two-columns Ye-IR-G-B pixel units are arranged alternately. The Ye pixels are pixels having selective infrared light cutoff filters formed thereon.

In the color filter array according to the eleventh example, if the strength of each signal produced by the individual pixels is Rᵢ, Gᵢ, Bᵢ, Yeᵢ, or IRᵢ, the relation between the strength of each color component and the signal strength of each pixel is expressed by a matrix calculation like the one illustrated in the following Formula (19).

$$( \begin{matrix}{R}_{i} \\ {G}_{i} \\ {B}_{i} \\ {Ye}_{i} \\ {IR}_{i}\end{matrix} ) = ( \begin{matrix}1 & 0 & 0 & 1 & 0 \\ 0 & 1 & 0 & 1 & 0 \\ 0 & 0 & 1 & 1 & 0 \\ 1 & 1 & 0 & 1 & 0 \\ 0 & 0 & 0 & 0 & 1\end{matrix} ) ( \begin{matrix}R \\ G \\ B \\ k I R \\ I R\end{matrix} ) \qquad ( 19 )$$

Then, as illustrated in the following Formula (20), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = ( \begin{matrix}0 & - 1 & 0 & 1 & 0 \\ - 1 & 0 & 0 & 1 & 0 \\ - 1 & - 1 & 1 & 1 & 0 \\ 1 & 1 & 0 & - 1 & 0 \\ 0 & 0 & 0 & 0 & 1\end{matrix} ) ( \begin{matrix}{R}_{i} \\ {G}_{i} \\ {B}_{i} \\ {Ye}_{i} \\ {IR}_{i}\end{matrix} ) \qquad ( 20 )$$

In the eleventh example, that is, in the color filter array in which half of R pixels are replaced with Ye pixels in the R-G-B-IR color filter array mentioned above, also, it is possible to determine, for each unit pixel array, also the infrared light transmittance k of a selective infrared light cutoff filter or the infrared light component kIR multiplied by the infrared light transmittance k. Accordingly, it becomes possible to perform computations for separation between visible light and infrared light components more precisely without being influenced by spatial or temporal variations of the infrared light transmittance k of the selective infrared light cutoff filters. In addition, similarly to the case of the tenth example, by adopting a configuration using complementary color filters, it becomes possible to raise the sensitivity to visible light as compared with the case that R, G, and B color filters are used.

### Modification Example of Eleventh Example

Advantages similar to those of the color filter array according to the eleventh example can also be attained with other arrays as long as pixels of individual colors included in a unit pixel array (including IR pixels and Ye pixels) include pixels having and not having selective infrared light cutoff filters and the transformation matrix corresponding to Formula (19) of the pixels has an inverse matrix (determinant det≠0).

### First Modification Example

A color filter array according to a first modification example of the eleventh example is illustrated in FIG. 24B. The color filter array according to the first modification example has a configuration in which Ye pixels are replaced with M pixels in the color filter array according to the eleventh example (see FIG. 24A). Specifically, the color filter array according to the first modification example has a unit pixel array configuration in which two-rows×two-columns R-IR-G-B pixel units and two-rows×two-columns Mg-IR-G-B pixel units are arranged alternately. The Mg pixels are pixels having selective infrared light cutoff filters formed thereon.

### Second Modification Example

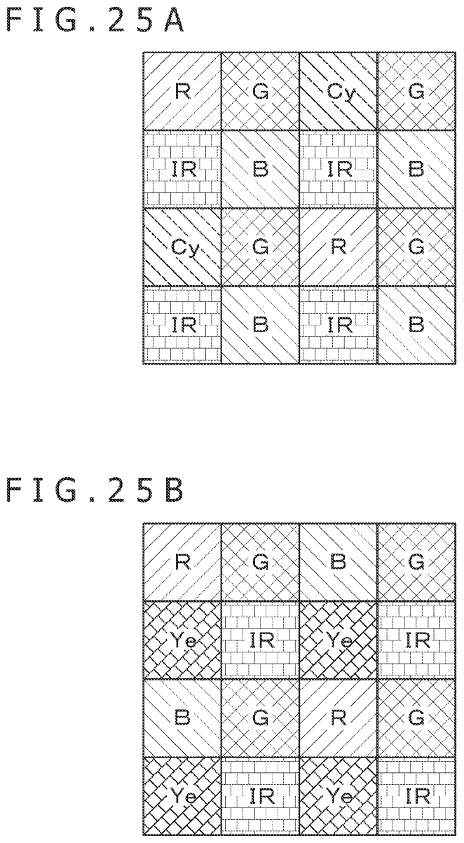

A color filter array according to a second modification example of the eleventh example is illustrated in FIG. 25A. The color filter array according to the second modification example has a configuration in which Ye pixels are replaced with Cy pixels in the color filter array according to the eleventh example (see FIG. 24A). Specifically, the color filter array according to the second modification example has a unit pixel array configuration in which two-rows×two-columns R-IR-G-B pixel units and two-rows×two-columns Cy-IR-G-B pixel units are arranged alternately. The Cy pixels are pixels having selective infrared light cutoff filters formed thereon.

### Third Modification Example

A color filter array according to a third modification example of the eleventh example is illustrated in FIG. 25B. The color filter array according to the third modification example has a configuration in which GI pixels are replaced with Ye pixels in the color filter array according to the fourth example (see FIG. 11). Specifically, the color filter array according to the third modification example has a unit pixel array configuration in which two-rows×two-columns R-Ye-G-IR pixel units and two-rows×two-columns B-Ye-G-IR pixel units are arranged alternately.

### Fourth Modification Example

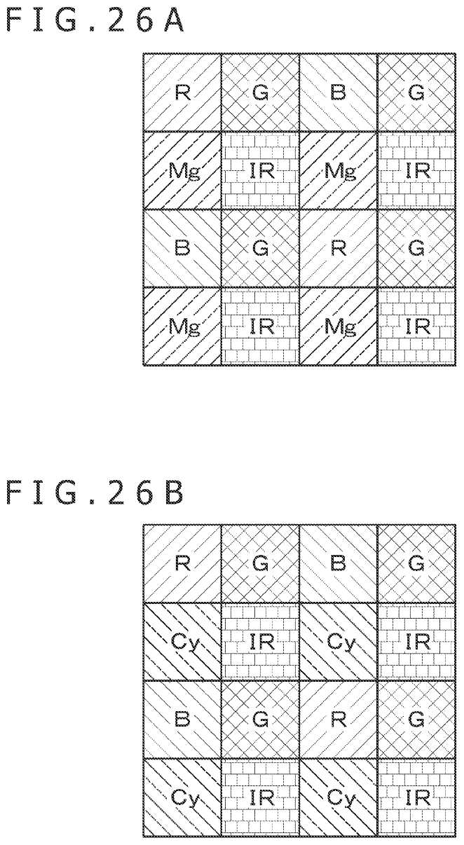

A color filter array according to a fourth modification example of the eleventh example is illustrated in FIG. 26A. The color filter array according to the fourth modification example has a configuration in which GI pixels are replaced with Mg pixels in the color filter array according to the fourth example (see FIG. 11). Specifically, the color filter array according to the fourth modification example has a unit pixel array configuration in which two-rows×two-columns R-Mg-G-IR pixel units and two-rows×two-columns B-Mg-G-IR pixel units are arranged alternately.

### Fifth Modification Example

A color filter array according to a fifth modification example of the tenth example is illustrated in FIG. 26B. The color filter array according to the fifth modification example has a configuration in which GI pixels are replaced with Cy pixels in the color filter array according to the fourth example (see FIG. 11). Specifically, the color filter array according to the fifth modification example has a unit pixel array configuration in which two-rows×two-columns R-Cy-G-IR pixel units and two-rows×two-columns B-Cy-G-IR pixel units are arranged alternately.

### Twelfth Example

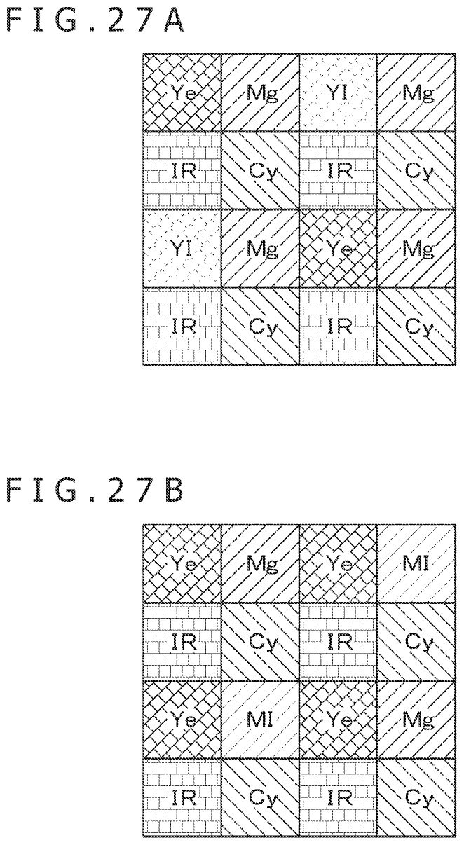

A twelfth example is an example in which all the color filters are replaced with complementary color filters. Similarly to the cases of the tenth example and the eleventh example, examples of the complementary color filters include Ye (yellow), Mg (magenta), and Cy (cyan) filters. A color filter array according to the twelfth example is illustrated in FIG. 27A.

The color filter array according to the twelfth example has a configuration in which R pixels are replaced with Ye pixels, G pixels are replaced with Mg pixels, and B pixels are replaced with Cy pixels in the color filter array according to the tenth example (see FIG. 21A). Specifically, the color filter array according to the twelfth example has a unit pixel array configuration in which two-rows×two-columns Ye-IR-Mg-Cy pixel units and two-rows×two-columns YI-IR-Mg-Cy pixel units are arranged alternately. Here, the Ye pixels, the Mg pixels, and the Cy pixels are pixels having selective infrared light cutoff filters formed thereon, and the YI pixels are Ye pixels not having selective infrared light cutoff filters formed thereon.

In the color filter array according to the twelfth example described above, the Ye, Mg, and Cy pixels are the first, second, and third pixels having selective infrared light cutoff filters 232 as well as filters that transmit wavelength bands corresponding to the first color light (yellow light), the second color light (magenta light), and the third color light (cyan light), respectively, that are visible light. The IR pixels are the fourth pixels having transmission characteristics of transmitting the infrared light wavelength band. The YI pixels are the fifth pixels having wavelength transmission characteristics that are different from all of the first pixels, the second pixels, the third pixels, and the fourth pixels.

In the color filter array according to the twelfth example, if the strength of each signal produced by the individual pixels is Yeᵢ, Mgᵢ, Cyᵢ, YIᵢ, or IRᵢ, the relation between the strength of each color component and the signal strength of each pixel is expressed by a matrix calculation like the one illustrated in the following Formula (21).

$$( \begin{matrix}Y e \\ M g \\ C y \\ Y e I \\ IR\end{matrix} ) = ( \begin{matrix}1 & 1 & 0 & 1 & 0 \\ 1 & 0 & 0 & 1 & 0 \\ 0 & 1 & 1 & 1 & 0 \\ 1 & 1 & 0 & 0 & 1 \\ 0 & 0 & 0 & 0 & 1\end{matrix} ) ( \begin{matrix}R \\ G \\ B \\ kIR \\ IR\end{matrix} ) \qquad ( 21 )$$

Then, as illustrated in the following Formula (22), by determining an inverse matrix of the transformation matrix and performing an inverse transformation, it becomes possible to perform a separation computation of each signal component of R, G, B, kIR, or IR, and the infrared light transmittance k of the selective infrared light cutoff filter as well, from the signal strength of each pixel.

$$( \begin{matrix}R \\ G \\ B \\ k I R \\ IR\end{matrix} ) = ( \begin{matrix}- 1 & 1 & 0 & 1 & - 1 \\ 1 & - 1 & 0 & 0 & 0 \\ - 2 & 1 & 1 & 1 & - 1 \\ 1 & 0 & 0 & - 1 & 1 \\ 0 & 0 & 0 & 0 & 1\end{matrix} ) ( \begin{matrix}Y e \\ M g \\ C y \\ YeI \\ IR\end{matrix} ) \qquad ( 22 )$$

In the twelfth example mentioned above, that is, in the color filter array in which all the color filters are replaced with complementary color filters, also, it is possible to determine, for each unit pixel array, also the infrared light transmittance k of a selective infrared light cutoff filter or the infrared light component kIR multiplied by the infrared light transmittance k. Accordingly, it becomes possible to perform computations for separation between visible light and infrared light components more precisely without being influenced by spatial or temporal variations of the infrared light transmittance k of the selective infrared light cutoff filters.

### Modification Example of Twelfth Example

Advantages similar to those of the color filter array according to the twelfth example can also be attained with other arrays as long as pixels of individual colors included in a unit pixel array (including IR pixels and YI pixels) include pixels having and not having selective infrared light cutoff filters and the transformation matrix corresponding to Formula (21) of the pixels has an inverse matrix (determinant det≠0).

### First Modification Example

A color filter array according to a first modification example of the twelfth example is illustrated in FIG. 27B. The color filter array according to the first modification example has a configuration in which YI pixels are replaced with Ye pixels and half of Mg pixels are replaced with MI pixels in the color filter array according to the twelfth example (see FIG. 27A). Specifically, the color filter array according to the first modification example has a unit pixel array configuration in which two-rows×two-columns Ye-IR-Mg-Cy pixel units and two-rows×two-columns Ye-IR-MI-Cy pixel units are arranged alternately.

### Second Modification Example

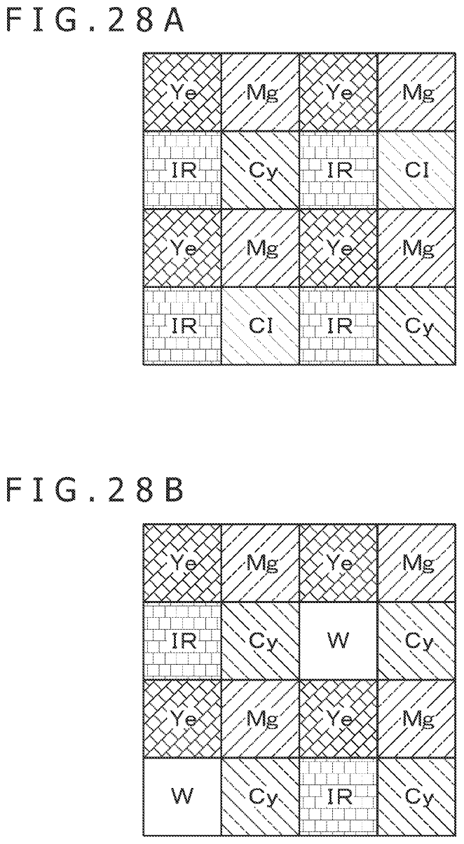

A color filter array according to a second modification example of the twelfth example is illustrated in FIG. 28A. The color filter array according to the second modification example has a configuration in which YI pixels are replaced with Ye pixels and half of Cy pixels are replaced with CI pixels in the color filter array according to the twelfth example (see FIG. 27A). Specifically, the color filter array according to the second modification example has a unit pixel array configuration in which two-rows×two-columns Ye-IR-Mg-Cy pixel units and two-rows×two-columns Ye-IR-Mg-CI pixel units are arranged alternately.

### Third Modification Example

A color filter array according to a third modification example of the twelfth example is illustrated in FIG. 28B. The color filter array according to the third modification example has a configuration in which YI pixels are replaced with Ye pixels and half of IR pixels are replaced with W pixels in the color filter array according to the twelfth example (see FIG. 27A). Specifically, the color filter array according to the third modification example has a unit pixel array configuration in which two-rows×two-columns Ye-IR-Mg-Cy pixel units and two-rows×two-columns Ye-W-Mg-Cy pixel units are arranged alternately.

### Fourth Modification Example

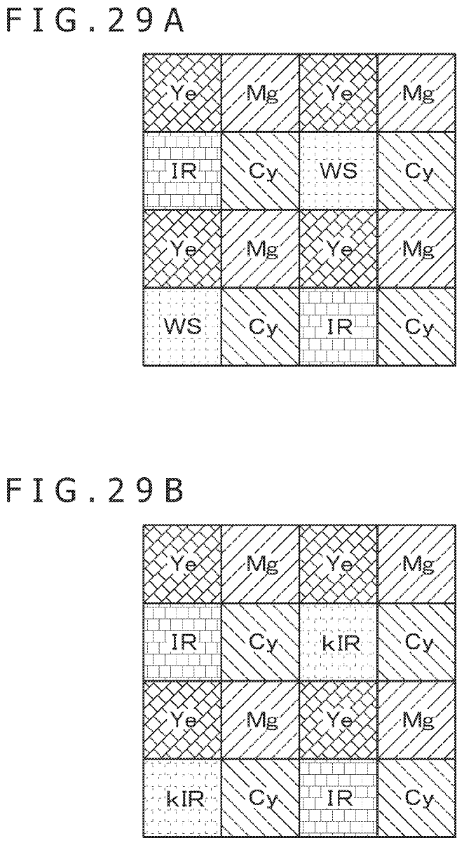

A color filter array according to a fourth modification example of the twelfth example is illustrated in FIG. 29A. The color filter array according to the fourth modification example has a configuration in which YI pixels are replaced with Ye pixels and half of IR pixels are replaced with WS pixels in the color filter array according to the twelfth example (see FIG. 27A). Specifically, the color filter array according to the fourth modification example has a unit pixel array configuration in which two-rows×two-columns Ye-IR-Mg-Cy pixel units and two-rows×two-columns Ye-WS-Mg-Cy pixel units are arranged alternately.

### Fifth Modification Example

A color filter array according to a fifth modification example of the twelfth example is illustrated in FIG. 29B. The color filter array according to the fifth modification example has a configuration in which YI pixels are replaced with Ye pixels and half of IR pixels are replaced with kIR pixels in the color filter array according to the twelfth example (see FIG. 27A). Specifically, the color filter array according to the fifth modification example has a unit pixel array configuration in which two-rows×two-columns Ye-IR-Mg-Cy pixel units and two-rows×two-columns Ye-kIR-Mg-Cy pixel units are arranged alternately.

### Thirteenth Example

In each example explained above, each color signal component, and the infrared light transmittance k of the selective infrared light cutoff filter 232 as well, is computed for each unit pixel array. In contrast, the third example is an example in which unit pixel arrays for transmittance computation are arranged dispersedly on a pixel array section on which a matrix of pixels is arranged. The third example is useful for a case in which the infrared light transmittance k of the selective infrared light cutoff filters 232 that is obtained at low precision for each area on the pixel array section (on the image-capturing surface of the image-capturing apparatus) suffices.

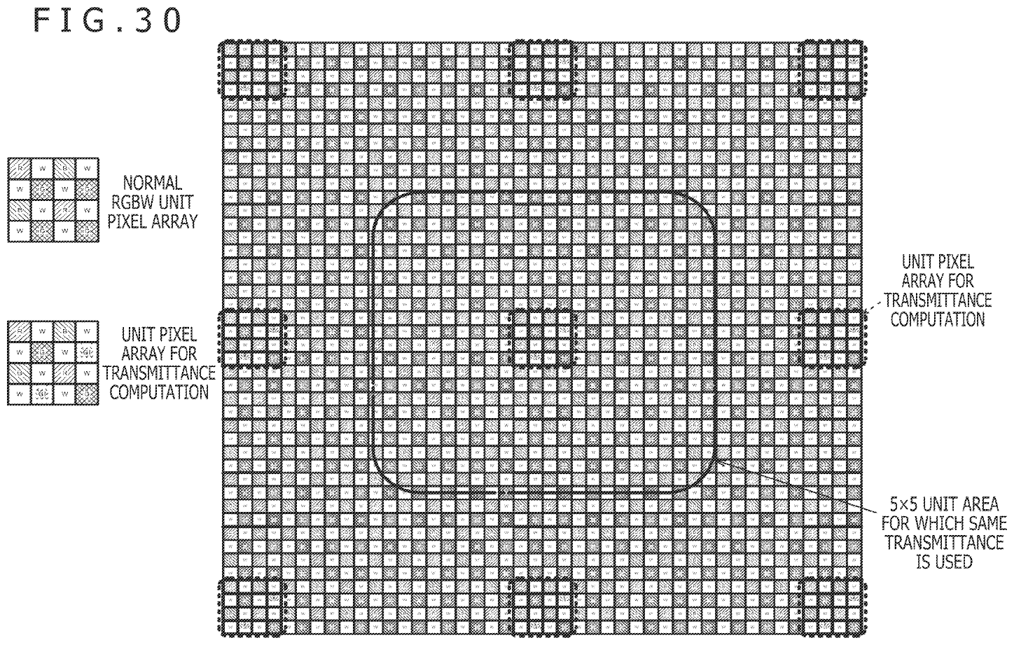

A color filter array according to the thirteenth example is illustrated in FIG. 30. Here, for example, a case that the unit pixel array according to the first example (see FIG. 3A) is arrayed for each of the 5×5 units of unit pixel arrays is illustrated. Here, other than the unit pixel arrays for transmittance computation used for determining the infrared light transmittance k of the selective infrared light cutoff filters 232, normal R-G-B-W unit pixel arrays are arranged. Then, for the infrared light transmittance k in a case where a matrix calculation is executed for the normal unit pixel arrays, the value of the infrared light transmittance k computed by using the unit pixel array for transmittance computation that is at the center of a 5×5 unit area is used.

Because, for a transmittance computation, the infrared light enters half of G pixels in the configuration of the color filter array according to the first example, noise increases in a G component computation so that a disadvantage of deterioration of pixels occurs. In contrast, in the thirteenth example, the unit pixel arrays for transmittance computation are arranged dispersedly on the image-capturing surface of the image-capturing apparatus so as to reduce the number of the unit pixel arrays for transmittance computation to the smallest required number. Accordingly, it becomes possible to suppress image quality deterioration resulting from the noise in the G component computation.

### Modification Examples of Embodiments

Although the technology of the present disclosure is explained thus far on the basis of preferable embodiments, the technology of the present disclosure is not limited to the embodiments. The configurations and structures of the image-capturing apparatus and the image-capturing system explained in the embodiments described above are illustrated as examples and can be changed as appropriate.

For example, only components (kIR) due to the infrared light transmittance k of the selective infrared light cutoff filters are considered as mixing of the infrared light (IR) into pixels having selective infrared light cutoff filters in the embodiments described above, this is not the sole example. That is, other than this, color mixing from pixels not having selective infrared light cutoff filters to pixels having selective infrared light cutoff filters (leakage of signal charges due to the infrared light on a substrate of the image-capturing apparatus) is possible to occur. Therefore, it may be thought that the infrared light transmittance k explained in the embodiments described above includes color components due to the color mixing.

In addition, although the embodiments described above are based on the premise that there is one type of film as the selective infrared light cutoff filters, two or more types of film may be formed, and the signal component of each signal band may be determined by treating two or more types of the infrared light transmittance k as unknown values in a matrix configuration with dimensions equal to or greater than 5×5.

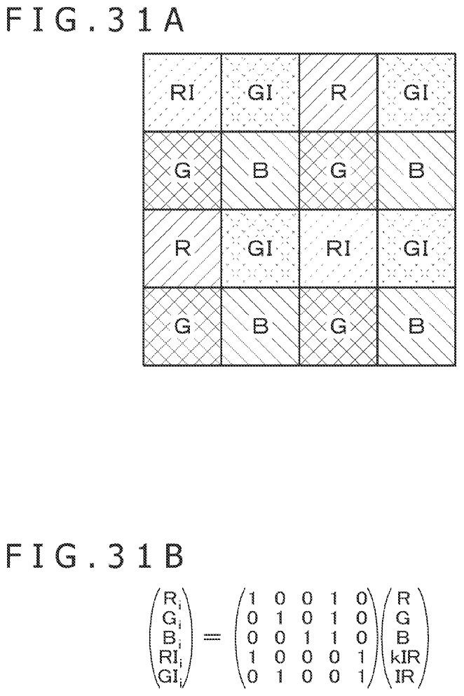

In addition, on the other hand, even if a set of pixels having color filters of the same colors and having and not having selective infrared light cutoff filters is included, there are color filter arrays for which individual pixel signals, and the infrared light transmittance k as well, cannot be determined. An example of such color filter arrays is illustrated in FIG. 31A. For a color filter array with such a configuration, the determinant inevitably becomes 0, and the inverse matrix cannot be determined in the transformation formula illustrated in FIG. 31B. Therefore, in order to realize the technology of the present disclosure, it is necessary to select an arrangement combination of selective infrared light cutoff filters for which the determinant of a transformation matrix does not become 0.

In addition, although a variety of modification examples are illustrated regarding each example in the embodiments described above, modification examples are not limited to those modification examples. For example, variations in cases that complementary color filters are used are explained below.

### (Cases Based on R, G, B, and W)

### First Variation

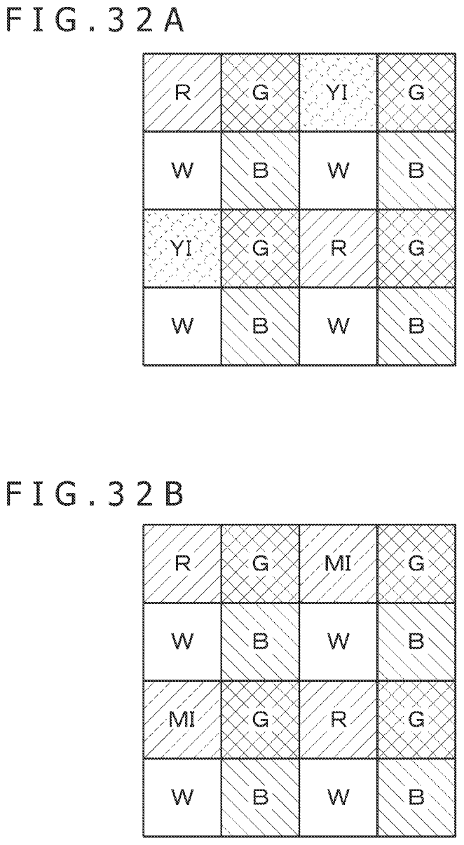

A color filter array according to a first variation is illustrated in FIG. 32A. The color filter array according to the first variation has a unit pixel array configuration in which two-rows×two-columns R-W-G-B pixel units and two-rows×two-columns YI-W-G-B pixel units are arranged alternately.

### Second Variation

A color filter array according to a second variation is illustrated in FIG. 32B. The color filter array according to the second variation has a unit pixel array configuration in which two-rows×two-columns R-W-G-B pixel units and two-rows×two-columns MI-W-G-B pixel units are arranged alternately.

### Third Variation

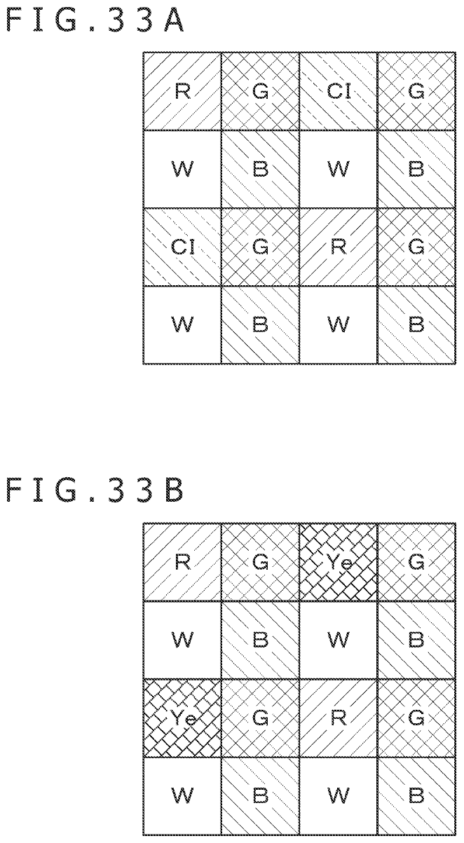

A color filter array according to a third variation is illustrated in FIG. 33A. The color filter array according to the third variation has a unit pixel array configuration in which two-rows×two-columns R-W-G-B pixel units and two-rows×two-columns CI-W-G-B pixel units are arranged alternately.

### Fourth Variation

A color filter array according to a fourth variation is illustrated in FIG. 33B. The color filter array according to the fourth variation has a unit pixel array configuration in which two-rows×two-columns R-W-G-B pixel units and two-rows×two-columns Ye-W-G-B pixel units are arranged alternately.

### Fifth Variation

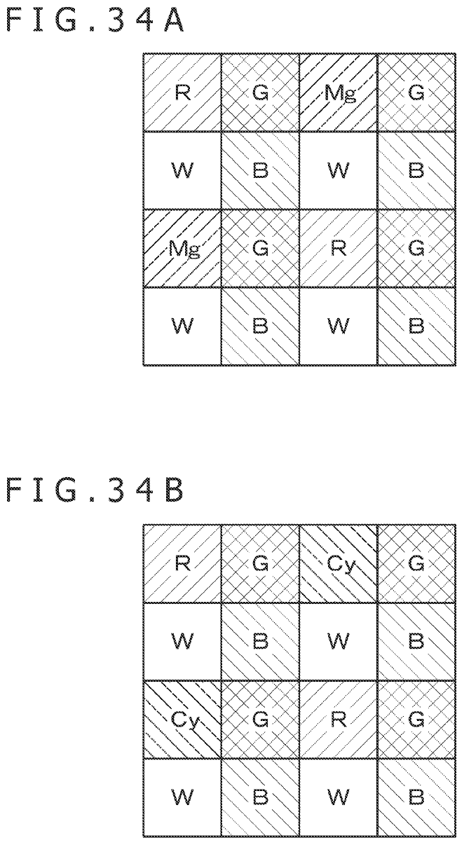

A color filter array according to a fifth variation is illustrated in FIG. 34A. The color filter array according to the fifth variation has a unit pixel array configuration in which two-rows×two-columns R-W-G-B pixel units and two-rows×two-columns Mg-W-G-B pixel units are arranged alternately.

### Sixth Variation

A color filter array according to a sixth variation is illustrated in FIG. 34B. The color filter array according to the sixth variation has a unit pixel array configuration in which two-rows×two-columns R-W-G-B pixel units and two-rows×two-columns Cy-W-G-B pixel units are arranged alternately.

### Seventh Variation

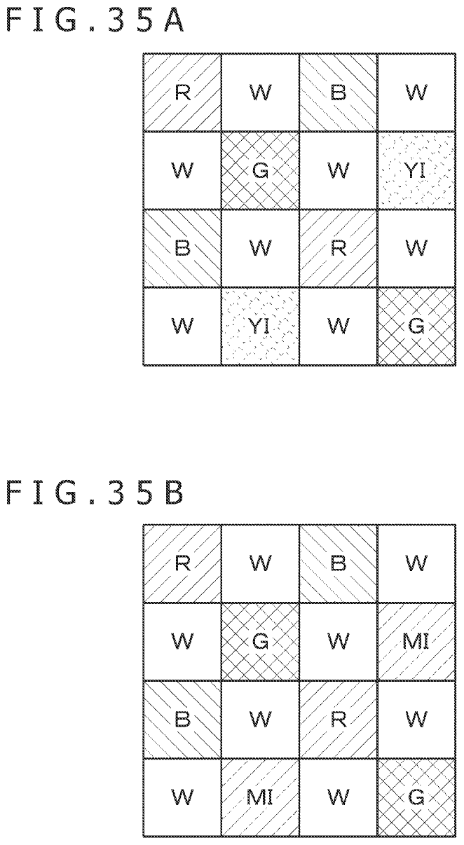

A color filter array according to a seventh variation is illustrated in FIG. 35A. The color filter array according to the seventh variation has a unit pixel array configuration in which two-rows×two-columns R-W-W-G pixel units and two-rows×two-columns B-W-W-YI pixel units are arranged alternately.

### Eighth Variation

A color filter array according to an eighth variation is illustrated in FIG. 35B. The color filter array according to the eighth variation has a unit pixel array configuration in which two-rows×two-columns R-W-W-G pixel units and two-rows×two-columns B-W-W-MI pixel units are arranged alternately.

### Ninth Variation

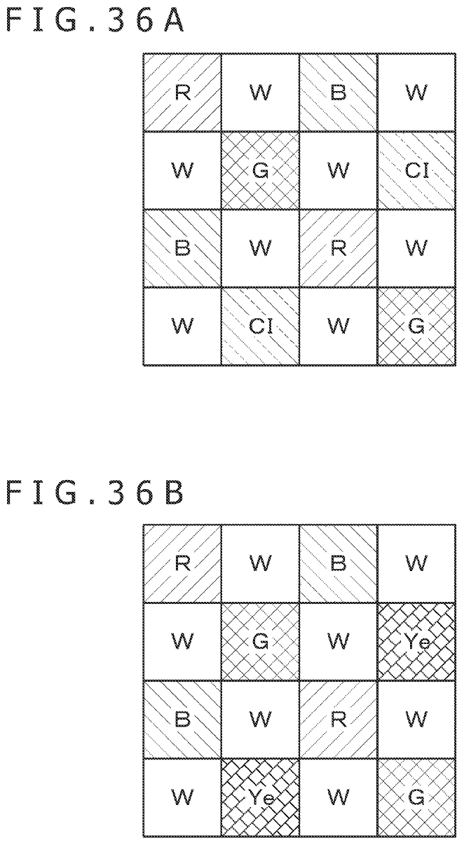

A color filter array according to a ninth variation is illustrated in FIG. 36A. The color filter array according to the ninth variation has a unit pixel array configuration in which two-rows×two-columns R-W-W-G pixel units and two-rows×two-columns B-W-W-CI pixel units are arranged alternately.

### Tenth Variation

A color filter array according to a tenth variation is illustrated in FIG. 36B. The color filter array according to the tenth variation has a unit pixel array configuration in which two-rows×two-columns R-W-W-G pixel units and two-rows×two-columns B-W-W-Ye pixel units are arranged alternately.

### Eleventh Variation

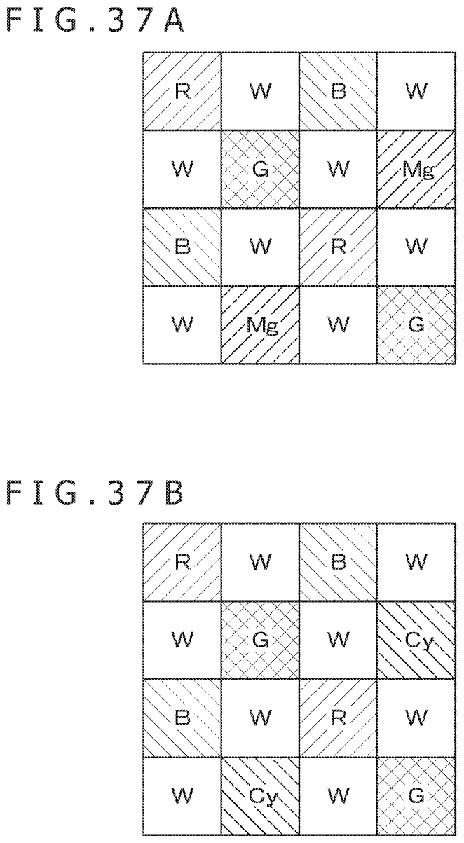

A color filter array according to an eleventh variation is illustrated in FIG. 37A. The color filter array according to the eleventh variation has a unit pixel array configuration in which two-rows×two-columns R-W-W-G pixel units and two-rows×two-columns B-W-W-Mg pixel units are arranged alternately.

### Twelfth Variation

A color filter array according to a twelfth variation is illustrated in FIG. 37B. The color filter array according to the twelfth variation has a unit pixel array configuration in which two-rows×two-columns R-W-W-G pixel units and two-rows×two-columns B-W-W-Cy pixel units are arranged alternately.

### (Cases Based on Ye, Mg, Cy, and W)

### Thirteenth Variation

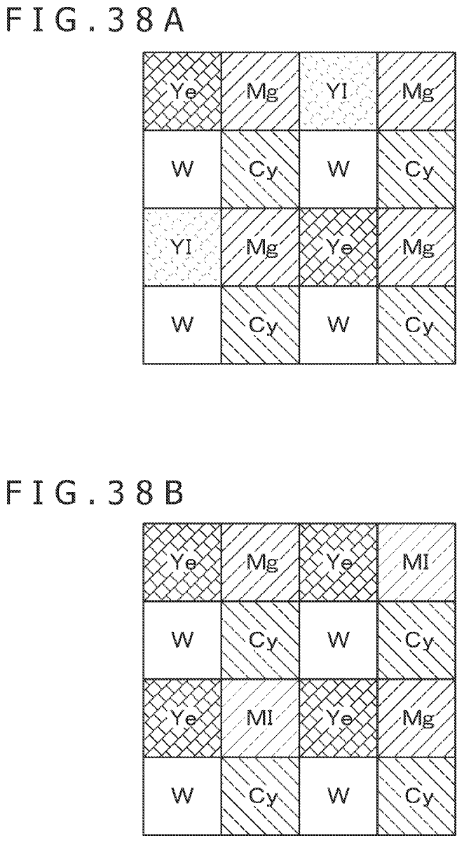

A color filter array according to a thirteenth variation is illustrated in FIG. 38A. The color filter array according to the thirteenth variation has a unit pixel array configuration in which two-rows×two-columns Ye-W-Mg-Cy pixel units and two-rows×two-columns MI-W-Mg-Cy pixel units are arranged alternately.

### Fourteenth Variation

A color filter array according to a fourteenth variation is illustrated in FIG. 38B. The color filter array according to the fourteenth variation has a unit pixel array configuration in which two-rows×two-columns Ye-W-Mg-Cy pixel units and two-rows×two-columns Ye-W-MI-Cy pixel units are arranged alternately.

### Fifteenth Variation

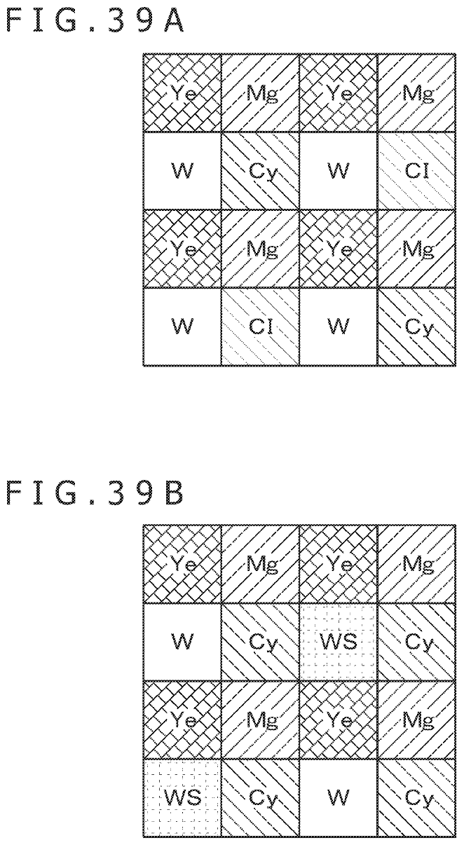

A color filter array according to a fifteenth variation is illustrated in FIG. 39A. The color filter array according to the fifteenth variation has a unit pixel array configuration in which two-rows×two-columns Ye-W-Mg-Cy pixel units and two-rows×two-columns Ye-W-Mg-CI pixel units are arranged alternately.

### Sixteenth Variation

A color filter array according to a sixteenth variation is illustrated in FIG. 39B. The color filter array according to the sixteenth variation has a unit pixel array configuration in which two-rows×two-columns Ye-W-Mg-Cy pixel units and two-rows×two-columns Ye-WS-Mg-Cy pixel units are arranged alternately.

### Seventeenth Variation

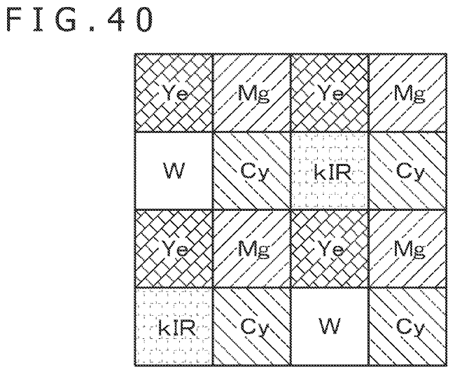

A color filter array according to a seventeenth variation is illustrated in FIG. 40. The color filter array according to the seventeenth variation has a unit pixel array configuration in which two-rows×two-columns Ye-W-Mg-Cy pixel units and two-rows×two-columns Ye-kIR-Mg-Cy pixel units are arranged alternately.

<Configurations that can be Adopted in Present Disclosure>

Note that the present disclosure can also adopt configurations like the ones mentioned below.

### <<A. Image-Capturing Apparatus>>

### [A-1]

An image-capturing apparatus including:

a first pixel having a first color filter that transmits a wavelength band corresponding to first color light that is visible light and an infrared light cutoff filter that limits transmission of an infrared light wavelength band;

a second pixel having a second color filter that transmits a wavelength band corresponding to second color light that is visible light and the infrared light cutoff filter;

a third pixel having a third color filter that transmits a wavelength band corresponding to third color light that is visible light and the infrared light cutoff filter;

a fourth pixel having transmission characteristics of transmitting the infrared light wavelength band; and

a fifth pixel having wavelength transmission characteristics that are different from all of the first pixel, the second pixel, the third pixel, and the fourth pixel.

### [A-2]

The image-capturing apparatus according to [A-1], further including:

a bandpass filter that transmits a wavelength band corresponding to red, a wavelength band corresponding to green, a wavelength band corresponding to blue, and a first infrared light wavelength band that is a band of wavelengths longer than wavelengths of the wavelength band corresponding to red, and cuts off a first wavelength band that is a wavelength band between the wavelength band corresponding to red and the first infrared light wavelength band and a second wavelength band that is a band of wavelengths longer than wavelengths of the first infrared light wavelength band.

### [A-3]

The image-capturing apparatus according to [A-2], in which

the infrared light cutoff filters are selective infrared light cutoff filters that limit transmission of the first infrared light wavelength band.

### [A-4]

The image-capturing apparatus according to any of [A-1] to

[A-3], in which

the first color filter is a red color filter,

the second color filter is a green color filter, and

the third color filter is a blue color filter.

### [A-5]

The image-capturing apparatus according to [A-4], in which

the fourth pixel is a white pixel not having a color filter formed thereon or an infrared light pixel having transmission characteristics of transmitting the infrared light wavelength band.

### [A-6]

The image-capturing apparatus according to [A-5], in which

the fifth pixel is a green pixel not having a selective infrared light cutoff filter formed thereon, a white pixel having the selective infrared light cutoff filter formed thereon, an infrared light pixel having the selective infrared light cutoff filter formed thereon, or a complementary color pixel not having the selective infrared light cutoff filter formed thereon.

### [A-7]

The image-capturing apparatus according to any of [A-1] to [A-3], in which

the first color filter, the second color filter, and the third color filter are complementary color filters.

### [A-8]

The image-capturing apparatus according to [A-7], in which

the first color filter is a yellow color filter,

the second color filter is a magenta color filter, and

the third color filter is a cyan color filter.

### [A-9]

The image-capturing apparatus according to [A-8], in which

the fourth pixel is an infrared light pixel having transmission characteristics of transmitting the infrared light wavelength band.

### [A-10]

The image-capturing apparatus according to [A-9], in which

the fifth pixel is a yellow color filter, a magenta color filter, or a cyan color filter not having the selective infrared light cutoff filter formed thereon.

### [A-11]

The image-capturing apparatus according to any of [A-1] to [A-10], in which

unit pixel arrays each including the first pixel, the second pixel, the third pixel, the fourth pixel, and the fifth pixel are arranged dispersedly on a pixel array section on which a matrix of pixels is arranged.

### <<B. Image-Capturing System>>

### [B-1]

An image-capturing system including:

a light source that emits infrared light; and

an image-capturing apparatus that is able to acquire visible light and infrared light, in which

the image-capturing apparatus includes
a first pixel having a first color filter that transmits a wavelength band corresponding to first color light that is visible light and an infrared light cutoff filter that limits transmission of an infrared light wavelength band,
a second pixel having a second color filter that transmits a wavelength band corresponding to second color light that is visible light and the infrared light cutoff filter,
a third pixel having a third color filter that transmits a wavelength band corresponding to third color light that is visible light and the infrared light cutoff filter,
a fourth pixel having transmission characteristics of transmitting the infrared light wavelength band, and
a fifth pixel having wavelength transmission characteristics that are different from all of the first pixel, the second pixel, the third pixel, and the fourth pixel.

### [B-2]

The image-capturing system according to [B-1], further including:

a bandpass filter that transmits a wavelength band corresponding to red, a wavelength band corresponding to green, a wavelength band corresponding to blue, and a first infrared light wavelength band that is a band of wavelengths longer than wavelengths of the wavelength band corresponding to red, and cuts off a first wavelength band that is a wavelength band between the wavelength band corresponding to red and the first infrared light wavelength band and a second wavelength band that is a band of wavelengths longer than wavelengths of the first infrared light wavelength band.

### [B-3]

The image-capturing system according to [B-2], in which

the infrared light cutoff filters are selective infrared light cutoff filters that limit transmission of the first infrared light wavelength band.

### [B-4]

The image-capturing system according to any of [B-1] to [B-3], in which

the first color filter is a red color filter,

the second color filter is a green color filter, and

the third color filter is a blue color filter.

### [B-5]

The image-capturing system according to [B-4], in which

the fourth pixel is a white pixel not having a color filter formed thereon or an infrared light pixel having transmission characteristics of transmitting the infrared light wavelength band.

### [B-6]

The image-capturing system according to [B-5], in which

the fifth pixel is a green pixel not having a selective infrared light cutoff filter formed thereon, a white pixel having the selective infrared light cutoff filter formed thereon, an infrared light pixel having the selective infrared light cutoff filter formed thereon, or a complementary color pixel not having the selective infrared light cutoff filter formed thereon.

### [B-7]

The image-capturing system according to any of [B-1] to [B-3], in which

the first color filter, the second color filter, and the third color filter are complementary color filters.

### [B-8]

The image-capturing system according to [B-7], in which

the first color filter is a yellow color filter,

the second color filter is a magenta color filter, and

the third color filter is a cyan color filter.

### [B-9]

The image-capturing system according to [B-8], in which

the fourth pixel is an infrared light pixel having transmission characteristics of transmitting the infrared light wavelength band.

### [B-10]

The image-capturing system according to [B-9], in which

the fifth pixel is a yellow color filter, a magenta color filter, or a cyan color filter not having the selective infrared light cutoff filter formed thereon.

### [B-11]

The image-capturing system according to any of [B-1] to [B-10], in which

unit pixel arrays each including the first pixel, the second pixel, the third pixel, the fourth pixel, and the fifth pixel are arranged dispersedly on a pixel array section on which a matrix of pixels is arranged.

### REFERENCE SIGNS LIST

1 . . . Camera system, 10 . . . Light source section, 11 . . . IR-LED, 12 . . . IR-LED driver, 20 . . . Image-capturing section, 21 . . . Lens, 22 . . . Dual bandpass filter, 23 . . . Image-capturing apparatus, 30 . . . Camera signal processing section, 231 . . . Pixel array section, 232 . . . Selective infrared light cutoff filter, 233 . . . Color filter, 234 . . . On-chip lens

1. An image-capturing apparatus comprising:
a first pixel having a first color filter that transmits a wavelength band corresponding to first color light that is visible light and an infrared light cutoff filter that limits transmission of an infrared light wavelength band;
a second pixel having a second color filter that transmits a wavelength band corresponding to second color light that is visible light and the infrared light cutoff filter;
a third pixel having a third color filter that transmits a wavelength band corresponding to third color light that is visible light and the infrared light cutoff filter;
a fourth pixel having transmission characteristics of transmitting the infrared light wavelength band; and
a fifth pixel having wavelength transmission characteristics that are different from all of the first pixel, the second pixel, the third pixel, and the fourth pixel.

2. The image-capturing apparatus according to claim 1, further comprising:
a bandpass filter that transmits a wavelength band corresponding to red, a wavelength band corresponding to green, a wavelength band corresponding to blue, and a first infrared light wavelength band that is a band of wavelengths longer than wavelengths of the wavelength band corresponding to red, and cuts off a first wavelength band that is a wavelength band between the wavelength band corresponding to red and the first infrared light wavelength band and a second wavelength band that is a band of wavelengths longer than wavelengths of the first infrared light wavelength band.

3. The image-capturing apparatus according to claim 2, wherein
the infrared light cutoff filters are selective infrared light cutoff filters that limit transmission of the first infrared light wavelength band.

4. The image-capturing apparatus according to claim 1, wherein
the first color filter is a red color filter,
the second color filter is a green color filter, and
the third color filter is a blue color filter.

5. The image-capturing apparatus according to claim 4, wherein
the fourth pixel is a white pixel not having a color filter formed thereon or an infrared light pixel having transmission characteristics of transmitting the infrared light wavelength band.

6. The image-capturing apparatus according to claim 5, wherein
the fifth pixel is a green pixel not having a selective infrared light cutoff filter formed thereon, a white pixel having the selective infrared light cutoff filter formed thereon, an infrared light pixel having the selective infrared light cutoff filter formed thereon, or a complementary color pixel not having the selective infrared light cutoff filter formed thereon.

7. The image-capturing apparatus according to claim 1, wherein
the first color filter, the second color filter, and the third color filter are complementary color filters.

8. The image-capturing apparatus according to claim 7, wherein
the first color filter is a yellow color filter,
the second color filter is a magenta color filter, and
the third color filter is a cyan color filter.

9. The image-capturing apparatus according to claim 8, wherein
the fourth pixel is an infrared light pixel having transmission characteristics of transmitting the infrared light wavelength band.

10. The image-capturing apparatus according to claim 9, wherein
the fifth pixel is a yellow color filter, a magenta color filter, or a cyan color filter not having the selective infrared light cutoff filter formed thereon.

11. The image-capturing apparatus according to claim 1, wherein
unit pixel arrays each including the first pixel, the second pixel, the third pixel, the fourth pixel, and the fifth pixel are arranged dispersedly on a pixel array section on which a matrix of pixels is arranged.

12. An image-capturing system comprising:
a light source that emits infrared light; and
an image-capturing apparatus that is able to acquire visible light and infrared light, wherein
the image-capturing apparatus includes
a first pixel having a first color filter that transmits a wavelength band corresponding to first color light that is visible light and an infrared light cutoff filter that limits transmission of an infrared light wavelength band,
a second pixel having a second color filter that transmits a wavelength band corresponding to second color light that is visible light and the infrared light cutoff filter,
a third pixel having a third color filter that transmits a wavelength band corresponding to third color light that is visible light and the infrared light cutoff filter,
a fourth pixel having transmission characteristics of transmitting the infrared light wavelength band, and
a fifth pixel having wavelength transmission characteristics that are different from all of the first pixel, the second pixel, the third pixel, and the fourth pixel.
